(19) United States
(12) Patent Application Publication
(10) Pub. No.: US 2016/0188018 A1
(43) Pub. Date: Jun. 30, 2016

(54) SYSTEM, DRAWING METHOD AND INFORMATION PROCESSING APPARATUS

(71) Applicant: Masato Handa, Kanagawa (JP)

(72) Inventor: Masato Handa, Kanagawa (JP)

(73) Assignee: RICOH COMPANY, LTD., Tokyo (JP)

(21) Appl. No.: 14/976,269

(22) Filed: Dec. 21, 2015

(30) Foreign Application Priority Data
Dec. 25, 2014 (JP) 2014-262808

(51) Int. Cl. G06F 3/0354

(52) U.S. Cl. CPC G06F 3/03545

(57) ABSTRACT

A system includes a first device configured to select an instruction position and a second device. The first device includes a physical quantity detection unit configured to detect a physical quantity acting on the first device at fixed time intervals; and a physical quantity transmission unit configured to send a transmission datum including the physical quantity at the fixed time intervals. The second device includes a position acquisition unit configured to acquire the instruction position, and generate information based on the instruction position; a transmission data reception unit configured to receive the transmission datum; a physical quantity extraction unit configured to extract the physical quantity at the fixed time intervals from the transmission datum; and an information display unit configured to reflect the extracted physical quantity at the fixed time intervals in the information generated based on the acquired instruction position, and to send the information to a display device.

### CROSS-REFERENCE TO RELATED APPLICATIONS

The present application claims the benefit of priority under 35 U.S.C. §119 of Japanese Patent Application No. 2014-262808, filed Dec. 25, 2014, the contents of which are incorporated herein by reference in their entirety.

### BACKGROUND OF THE INVENTION

1. Field of the Invention

The disclosures herein generally relate to a system, a drawing method and an information processing apparatus.

2. Description of the Related Art

Electronic whiteboards which are obtained by adding an information capturing function, a display function, a communication function or the like to conventional whiteboards have been known. Information which a user writes on the electronic whiteboard is accumulated as coordinate data, and the electronic whiteboard draws on a display surface of a display device. Therefore, the user can draw characters and figures in the same way as on the conventional whiteboard, and store drawing data or send the data to another electronic whiteboard or a terminal to utilize the data.

An electronic pen can be provided as a tool for inputting coordinate values on the display surface by the user. In a case where the electronic pen has a function of communicating with the electronic whiteboard, functionality and operability of the electronic whiteboard can be enhanced. For example, in a case where the electronic pen has a function of writing pressure, the electronic pen sends the writing pressure to the electronic whiteboard with a predetermined frequency, to change a thickness of a line to be drawn depending on the writing pressure. Viewed from the user, since a strongly drawn line is displayed thickly, it obtains usability as if the user actually draws with a pen (see for example, Japanese Patent No. 4143462). Japanese Patent No. 4143462 discloses a pen inputting and displaying apparatus in which an electronic pen changes a signal width of an infrared signal depending on writing pressure information and sends an infrared ray.

### SUMMARY OF THE INVENTION

It is a general object of at least one embodiment of the present invention to provide a system, a drawing method, an information processing apparatus and a storage medium that substantially obviate one or more problems caused by the limitations and disadvantages of the related art.

In one embodiment, a system includes a first device configured to select an instruction position; and a second device. The first device includes a physical quantity detection unit configured to detect a physical quantity at fixed time intervals, the physical quantity acting on the first device; and a physical quantity transmission unit configured to send a transmission datum including the physical quantity at the fixed time intervals detected by the physical quantity detection unit. The second device includes a position acquisition unit configured to acquire the instruction position selected by the first device, and generate information based on the instruction position; a transmission data reception unit configured to receive the transmission datum; a physical quantity extraction unit configured to extract the physical quantity at the fixed time intervals from the transmission datum received by the transmission data reception unit; and an information display unit configured to reflect the physical quantity at the fixed time intervals extracted by the physical quantity extraction unit in the information generated by the position acquisition unit based on the acquired instruction position, and to send the information to a display device.

In another embodiment, a drawing method is performed in a system including a first device configured to select an instruction position and a second device configured to acquire the instruction position. The drawing method includes detecting a physical quantity at fixed time intervals, the physical quantity acting on the first device; sending from the first device a transmission datum including the detected physical quantity at the fixed time intervals; acquiring at the second device the instruction position selected by the first device, and generating information based on the instruction position; receiving at the second device the transmission datum; extracting at the second device the physical quantity at the fixed time intervals from the received transmission datum; and reflecting the extracted physical quantity at the fixed time intervals in the information generated based on the acquired instruction position, and sending the information to a display device.

In yet another embodiment, an information processing apparatus receives a transmission datum from a first device configured to select an instruction position, the first device including a physical quantity detection unit configured to detect a physical quantity acting on the first device at fixed time intervals; and a physical quantity transmission unit configured to send the transmission datum including the physical quantity at the fixed time intervals detected by the physical quantity detection unit. The information processing apparatus includes a position acquisition unit configured to acquire the instruction position selected by the first device, and generate information based on the instruction position; a transmission data reception unit configured to receive the transmission datum; a physical quantity extraction unit configure to extract the physical quantity at the fixed time intervals from the transmission datum received by the transmission data reception unit; and an information display unit configured to reflect the physical quantity at the fixed time intervals extracted by the physical quantity extraction unit in the information generated by the position acquisition unit based on the acquired instruction position, and to send the information to a display device.

### BRIEF DESCRIPTION OF THE DRAWINGS

Other objects and further features of embodiments will become apparent from the following detailed description when read in conjunction with the accompanying drawings, in which:

FIG. 1A is a schematic view illustrating an example of a drawing system according to related art;

FIG. 1B is a schematic view illustrating an example of a drawing system according to a first embodiment;

FIG. 2 is a schematic view illustrating an example of the drawing system according to the first embodiment;

FIG. 3 is a schematic configuration diagram illustrating an example of an electronic pen according to the first embodiment;

FIG. 4 is a hardware configuration diagram illustrating an example of a computer according to the first embodiment;

FIG. 5 is a functional block diagram illustrating an example of a drawing system having an electronic pen and a computer according to the first embodiment;

FIGS. 6A and 6B are diagrams for schematically explaining an example of a packet format of transmission data according to the first embodiment;

FIG. 7 is a sequence diagram illustrating an example of a procedure of sending transmission data to the computer by the electronic pen according to the first embodiment;

FIGS. 8A and 8B are flowcharts illustrating an example of operation procedures of the electronic pen and the computer according to the first embodiment;

FIG. 9 is a functional block diagram illustrating an example of a drawing system having an electronic pen and a computer according to a second embodiment;

FIG. 10 is a sequence diagram illustrating an example of a procedure of sending transmission data to the computer by the electronic pen according to the second embodiment:

FIGS. 11A and 11B are flowcharts illustrating an example of operation procedures of the electronic pen and the computer according to the second embodiment;

FIGS. 12A and 12B are diagrams illustrating an example of a data part of a transmission datum including three pieces of writing pressure information according to the second embodiment;

FIG. 13 is a functional block diagram illustrating an example of a drawing system having an electronic pen and a computer according to a third embodiment;

FIG. 14 is a diagram for explaining an example of a method of interpolating writing pressure information according to the third embodiment;

FIGS. 15A and 15B are diagrams for explaining an example of reflecting the writing pressure information in drawing data according to the third embodiment;

FIG. 16 is a sequence diagram illustrating an example of a procedure of sending transmission data to the computer by the electronic pen according to the third embodiment;

FIG. 17 is a flowchart illustrating an example of a procedure of receiving transmission data by the computer according to the third embodiment;

FIGS. 18A and 18B are diagrams for schematically explaining a data part of the transmission data according to the third embodiment;

FIGS. 19A and 19B are diagrams for schematically explaining an example of a drawing system according to a fourth embodiment;

FIG. 20 is a functional block diagram illustrating an example of the drawing system having an electronic pen and a computer according to the fourth embodiment;

FIG. 21 is a sequence diagram illustrating an example of a procedure of sending transmission data to the computer by the electronic pen according to the fourth embodiment:

FIGS. 22A and 22B are flowcharts illustrating an example of operation procedures of the electronic pen and the computer according to the fourth embodiment; and

FIGS. 23A to 23D are diagrams for explaining an example of a method for identifying by the computer an electronic pen used for inputting coordinates in a case where there are a plurality of electronic pens.

### DESCRIPTION OF THE PREFERRED EMBODIMENTS

In the following, embodiments of the present invention will be described with reference to the accompanying drawings.

### First Embodiment

### Outline of a Drawing System According to a First Embodiment

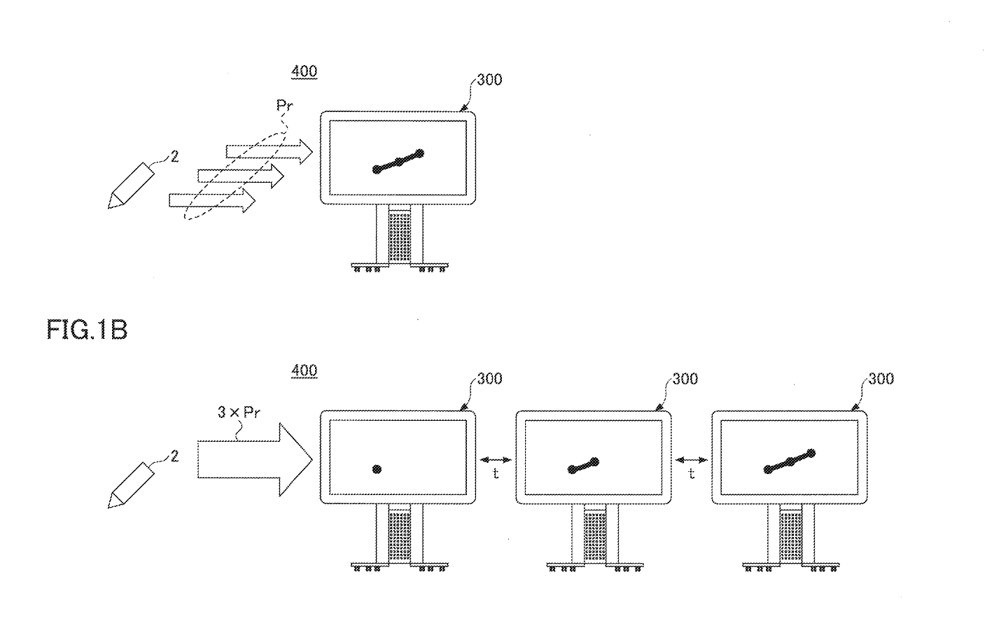

FIG. 1B is a schematic view illustrating an example of a drawing system 400 according to a first embodiment. FIG. 1A schematically illustrates transmission of writing pressure information which is schematically shown for comparison. An electronic pen 2 in FIG. 1A sends a piece of writing pressure information Pr to an electronic whiteboard 300 by one transmission. Therefore, in order to display so that, for example, a thickness of a line changes smoothly on the electronic whiteboard 300, it is necessary to send the writing pressure information Pr with high frequency.

FIG. 1B schematically illustrates transmission of writing pressure information according to the first embodiment. The electronic pen 2 according to the first embodiment sends n pieces of writing pressure information Pr (n is an integer, and assumed here to be three) to the electronic whiteboard 300 by one transmission. Therefore, even if the electronic pen 2 does not send writing pressure information with high frequency, the electronic whiteboard 300 can reflect the writing pressure information in a thickness of a line to display so that the thickness of the line changes smoothly.

Since the electronic whiteboard 300 detects a plurality of coordinate sets of the electronic pen 2 while the electronic pen 2 sends the n pieces of writing pressure information Pr, the n pieces of writing pressure information Pr are preferably associated with the separated coordinate sets, respectively. The electronic whiteboard 300 reflects the n pieces of writing pressure information in a thickness of a line at a time interval of t ms. Then, even if n pieces of writing pressure information Pr are sent at once, the electronic whiteboard 300 can change a thickness of a line to display in the same way as in the case of sending pieces of writing pressure information one by one.

<Regarding Technical Terms>

Terms used in the first embodiment will be described.

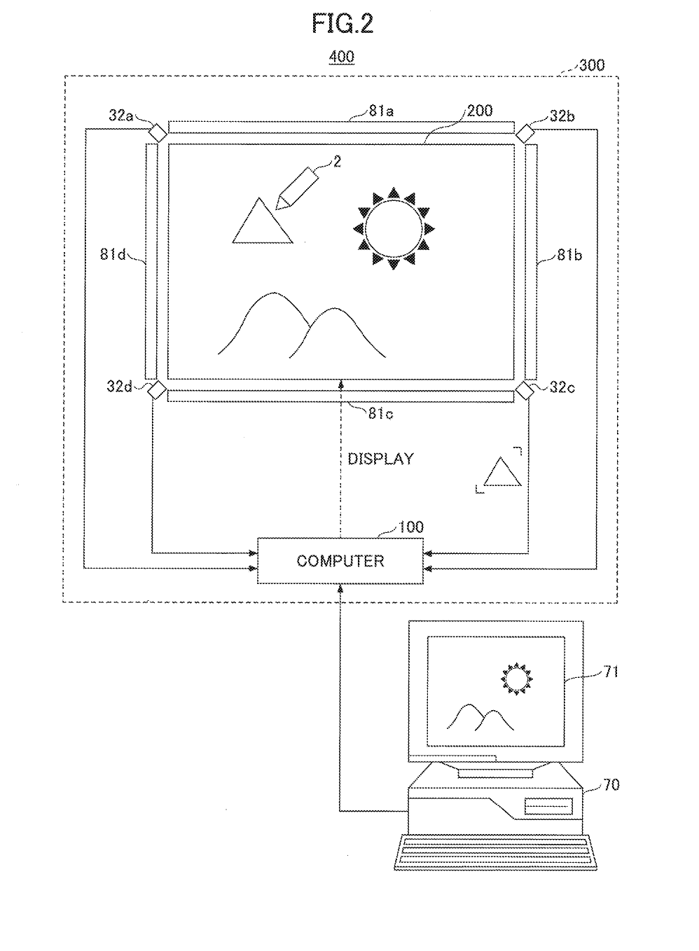

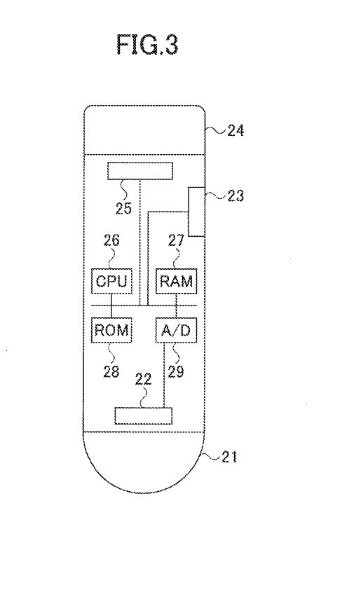

An electronic pen is a member having a shape of a pen with a light emitting part. The electronic pen is provided with a function of communicating with the electronic whiteboard 300. A user selects a position on a display surface of a display device 200 (See FIG. 2) using the electronic pen 2. Meanwhile, the user can select a position on the display surface of the display 200 also by using a finger or a member having a shape of pen which is not the electronic pen 2 to input coordinate values. The display device 200 is an example of a display apparatus.

The integer n is mainly more than one. However, one piece of writing pressure information may be sent, as shown in second and fourth embodiments, which will be described later.

The coordinate set in the first embodiment means position information indicating a position of the electronic pen 2 on the display surface of the display device 200 of the electronic whiteboard 300. This coordinate set can be represented by a world coordinate system indicating a point with an origin set arbitrarily and a three dimensional coordinate system. Or, it may be represented using a two dimensional coordinate system where an origin is a corner (e.g. upper left corner) of the display device 200.

<Example of Configuration>

FIG. 2 is a schematic view illustrating an example of the drawing system 400 according to the first embodiment. The drawing system 400 includes the display device 200, four imaging units 32a to 32d (in the following, in a case of describing the four imaging units without distinguishing each other, denoted as imaging unit 32), four retroreflection plates 81a to 81d (in the following, in a case of describing the four retroreflection plates without distinguishing each other, denoted as retroreflection plate 81), and a computer 100.

Moreover, an image output device 70 is coupled to the computer 100. However, the image output device 70 may not be coupled to the computer 100. That is, the electronic whiteboard 300 includes at least the display device 200 and the computer 100, and may include another appropriate member.

The display device 200 may be any type of device such as a liquid crystal display device, a plasma emission type display, an organic EL (electroluminescence) type display, an electrophoretic type display or a field emission display (FED). Moreover, in addition to self-luminous type displays, the display may be configured by projecting screen images by using a projection device such as a projector or a rear-projection apparatus. In the first embodiment, the display device 200 is not required to have a touch panel. But, it may have a touch panel.

The four retroreflection plates 81a to 81d may be fixed around the display device 200, or may be attached detachably. The retroreflection plate 81 is not necessary in drawing using the electronic pen 2. However, in a case where the retroreflection plates 81 is arranged, the user can input a coordinate set by using a finger or a member having a shape of a pen which does not have a light emitting part.

In the computer 100, a program for drawing system 119 which will be described later corresponding to the drawing system 400 is installed. In a case where the computer 100 executes the program for drawing system 119, based on an image captured by the imaging unit 32, a coordinate set selected by the user with the electronic pen 2 is detected. The computer 100 draws visual information including a point, a line or the like on the display device 200 based on the coordinate set.

Moreover, the computer 100, in order to display a menu (an example of visual information) for receiving an operation for the drawing system 400, determines which menu is selected based on a coordinate set and receives the operation.

For example, in a case where after touching a menu for drawing a line the user draws a figure on the display surface of the display device 200 with the electronic pen 2, the computer 100 acquires a coordinate set of a position which the electronic pen 2 touches in real time, and creates time-series coordinates. The computer 100 connects the time-series coordinates to create a line, and displays it on the display device 200.

Meanwhile, the menu includes an instruction for color, thickness, a type or the like of a line. The user can select these menus to specify a line to be drawn. Meanwhile, regarding the thickness of lines, in a case where the user selects the thickness, the user's selection has a priority. In a case where the user does not select the thickness of lines, a line having a thickness depending on writing pressure information sent from the electronic pen 2 with respect to a predetermined basic thickness of lines is drawn. In a case where the electronic pen 2 does not send the writing pressure information to the computer 100 (e.g. in a case where the electronic pen 2 does not have a function of detecting writing pressure), a line having the predetermined basic thickness of lines is drawn.

Meanwhile, the menu to be received includes, in addition to the instructions for drawing, an instruction for storing entire content drawn on the display surface (in the following, referred to as a page), redisplaying a page, flipping a page, printing a page, or sending a page to a PC (Personal Computer) of the user or the like.

For example, in FIG. 2, since the user moves the electronic pen 2 along a shape of a triangle, the computer records a series of coordinates composing a triangle. Then, the computer 100 combines an image, which the image output device 70 outputs to the display device 71, with the triangle (the image or an image with which the triangle is combined is an example of visual information), to display on the display device 200. For the user, it seems that the user draws a triangle.

In this way, even if the display device 200 does not have a touch panel, the user can perform various operations for the drawing system 400. Moreover, by using the retroreflection plate 81, the user can operate the drawing system 400 by using a finder or a member having a shape of a pen without using the electronic pen 2.

Next, with reference to FIG. 3, a schematic configuration of the electronic pen 2 will be described. FIG. 3 is a schematic configuration diagram illustrating an example of the electronic pen 2. The electronic pen 2 includes an apical part 21 which emits infrared light by an LED or the like, a contact detection unit 22 which detects writing pressure upon the apical part 21 physically contacting the display surface of the display device 200, a wireless notification unit 23 which notifies wirelessly the computer 100 of writing pressure information of the writing pressure detected by the contact detection unit 22, a rear end part 24 which operates in a direction of an axis of the electronic pen 2, a rear end switch 25 which detects that the rear end part 24 is physically pressed on the display surface of the display device 200, a CPU 26 which controls the entirety of the electronic pen 2, a RAM 27, a ROM 28 and an A/D conversion unit 29. The ROM 28 stores a program for electronic pen, and the CPU 26 executes the program for electronic pen to provide the following functions. Meanwhile, the electronic pen 2 has a generic configuration, which an information processing apparatus such as a microcomputer has, in addition to the configuration as shown in the drawings.

The contact detection unit 22 includes a high polymer pressure-membrane film or the like. The writing pressure detected by the contact detection unit 22 is sent to the A/D conversion unit 29. The A/D conversion unit 29 converts the writing pressure which is an analog signal into the writing pressure information which is a digital signal. The CPU 26 compares the writing pressure with a threshold, and can detect that the apical part 21 contacts the display surface (in this case, the CPU 26 generates a contact signal) and that the apical part 21 is separated from the display surface (in this case, the CPU 26 generates a non-contact signal). In a case where the apical part 21 contacts the display surface, the CPU 26 causes the light emitting part of the apical part 21 to emit light, and in a case where the apical part 21 is separated from the display surface, the CPU 26 turns off the light of the light emitting part. Accordingly, power consumption can be reduced. Or, the apical part 21 may always emit light. In this case, a sensor such as an acceleration sensor for estimating a usage state of the user is installed. The CPU 26 determines based on the output thereof whether the user uses it. In a case where the user does not use it, the light emitting part is turned off.

Moreover, in a case where the rear end part 24 is pressed on the display surface of the display device 200, the rear end switch 25 turns ON, and the CPU 26 detects ON information. Moreover, in a case where the rear end part 24 is separated from the display surface of the display device 200, the rear end switch 25 turns OFF, and the CPU 26 detects OFF information.

Moreover, the electronic pen 2 preferably stores attribute information such as a unique ID in the ROM or the like. Accordingly, even in a case where there are a plurality of electronic pens 2, the computer 100 can identify the electronic pen 2 and associate it with writing pressure information.

The wireless notification unit 23 communicates with the computer 100 by, for example, Bluetooth (trademark registered). But, the wireless notification unit 23 may communicate by infrared light, a wireless LAN, ultrasonic waves, visible light communication or the like. The wireless notification unit 23 can send a contact signal/non-contact signal, ON information, ID and writing pressure information to the electronic whiteboard 300.

In a case where the electronic whiteboard 300 receives the contact signal, a light source, which will be described later, irradiating the retroreflection plate is turned off, and in a case where the electronic whiteboard 300 receives the non-contact signal, the light source irradiating the retroreflection plate is turned on. Upon turning off the light source irradiating the retroreflection plate, the imaging unit 32 can capture the light emitting part of the electronic pen 2. Upon turning on the light source irradiating the retroreflection plate, the imaging unit can capture the finger or the member having a shape of a pen.

Moreover, in a case where the electronic whiteboard 300 receives the ON signal, drawing data displayed at a detected coordinate set of the electronic pen 2 is erased. That is, the user rubs the display surface of the display device 200 with the rear-end part 24 of the electronic pen 2, to use the electronic pen 2 as a rubber eraser.

Meanwhile, the information which the electronic pen 2 sends to the computer 100 of the electronic whiteboard 300 is not limited to them (contact signal/non-contact signal, ON information ID and writing pressure information).

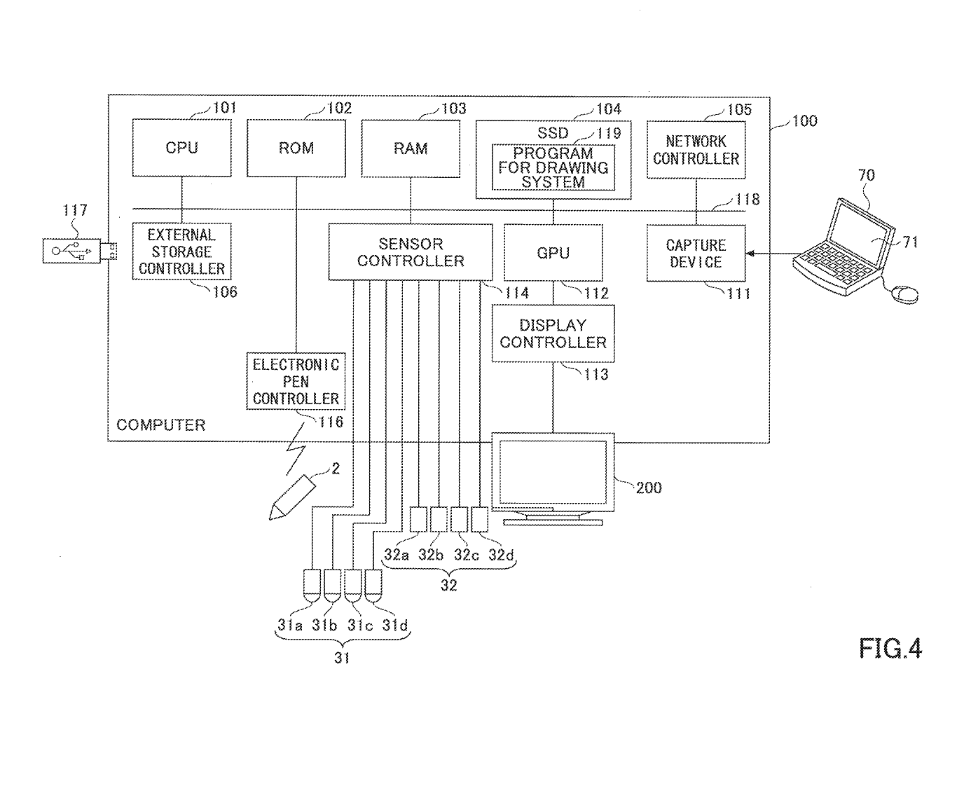

Next, with reference to FIG. 4, a hardware configuration of the computer 100 will be described. FIG. 4 is a hardware configuration diagram illustrating an example of the computer 100. The computer 100 includes a CPU 101 electrically coupled via a bus line 118 such as an address bus or a data bus, a ROM 102, a RAM 103, an SSD (Solid State Drive) 104, a network controller 105, an external storage controller 106, an electronic pen controller 116, a sensor controller 114, a GPU (Graphic Processor Unit) 112 and a capture device 111. Furthermore, the computer 100 according to the first embodiment includes a display controller 113 coupled to the GPU 112.

The CPU 101 executes a program for drawing system 119, to control an overall operation of the drawing system 400. The ROM 102 stores a program to be executed by the CPU 101 mainly upon starting up the drawing system 400, such as an IPL (Initial Program Loader). The RAM 103 is a work memory upon the CPU 101 executing the program for drawing system 119. The SSD 104 is a non-volatile memory storing the program for drawing system 119 or various types of data.

The network controller 105 performs a process based on the communication protocol upon the computer 100 communicating with another device via a network. Meanwhile, the network is a LAN, a WAN to which a plurality of LANs are coupled, or the like. The WAN may be the Internet, for example. Moreover, the network may include a mobile telephone network. Moreover, the network controller 105 may be coupled directly to another device via a dedicated line. The other device includes another drawing system 400, in addition to a server or the like. In a case where the network controller 105 is coupled to the other drawing system 400, the user sends/receives drawing content to/from the other drawing system 400, thereby at respective locations the drawing systems 400 can display the same drawing content on the display devices 200.

The external storage controller 106 writes/reads data into/from a detachable external memory 117 according to instructions from the CPU 101. The external memory 117 is, for example, a flash memory such as a USB memory or an SD card.

The electronic pen controller 116 wirelessly communicates with the wireless notification unit 23 of the electronic pen 2, to receive contact signal/non-contact signal, ON information, ID, writing pressure information and the like. Therefore, the computer 100 can detect whether the user is drawing using the electronic pen 2. Meanwhile, in a case where the computer 100 does not communicate with the electronic pen 2, the electronic pen controller 11 may not be provided.

To the sensor controller 114, four imaging units 32a to 32d are coupled. The imaging units 32a to 32d have sensitivity for infrared light emitted from the electronic pen 2, infrared light reflected at the retroreflection plate and the like. The imaging units 32a to 32d may be CMOS (complementary metal-oxide semiconductor) or CCD (charge-coupled device) image sensors for acquiring two-dimensional images, or may be image sensors for acquiring one-dimensional images, such as linear image sensors. Moreover, the imaging units 32a to 32d are assumed to represent overall devices for detecting light planarly and linearly, such as a position detection device called PSD (position sensitive detector).

With at least two imaging units 32, one or more coordinates can be detected. As shown in FIG. 2, the imaging units 32 are arranged at the corners of the display device 200, light axes of which are directed into directions approximately parallel to the display surface of the display device 200. Accordingly, an instruction member near the display surface (within a predetermined distance from the display surface) can be captured. The above-described imaging region may be called a peripheral part. The greater the number of the imaging units 32 is, the greater a number of coordinates that can be detected simultaneously is. The sensor controller 114 detects a coordinate set by using the triangulation method from images captured by the imaging units 32a to 32d.

Moreover, to the sensor controller 114, four light sources 31 are coupled. The light source 31 is arranged, for example, adjacent to the corresponding imaging unit 32 or integrally with the imaging unit 32, and irradiates the retroreflection plate 81. The light source 31 emits, for example, infrared light. Since the imaging unit 32 has sensitivity for infrared light or the like, it is possible to capture a shadow of a hand or the member having a shape of a pen without capturing light of room lighting or the like. As described above, the CPU 101 turns on the light source 31 while the non-contact signal is received from the electronic pen 2 alone. Therefore, the user can input a coordinate set using the electronic pen 2 and also using a finger or a member having a shape of a pen.

The capture device 111 captures a screen image which the image output device 70 displays on the display device 71.

The GPU 112 is a drawing dedicated processor, which calculates pixel values of respective pixels of the display device 200. The display controller 113 outputs an image created by the GPU 112 to the display device 200.

Meanwhile, the program for drawing system 119 may be distributed in a state stored in the external memory 117, or may be downloaded from a server of a manufacturer of the drawing system 400 or from a server of a company, which is a request destination of the manufacturer, via the network controller 105. Moreover, the program for drawing system 119 may be distributed in a distribution form or in an executable form.

<<Regarding Function>>

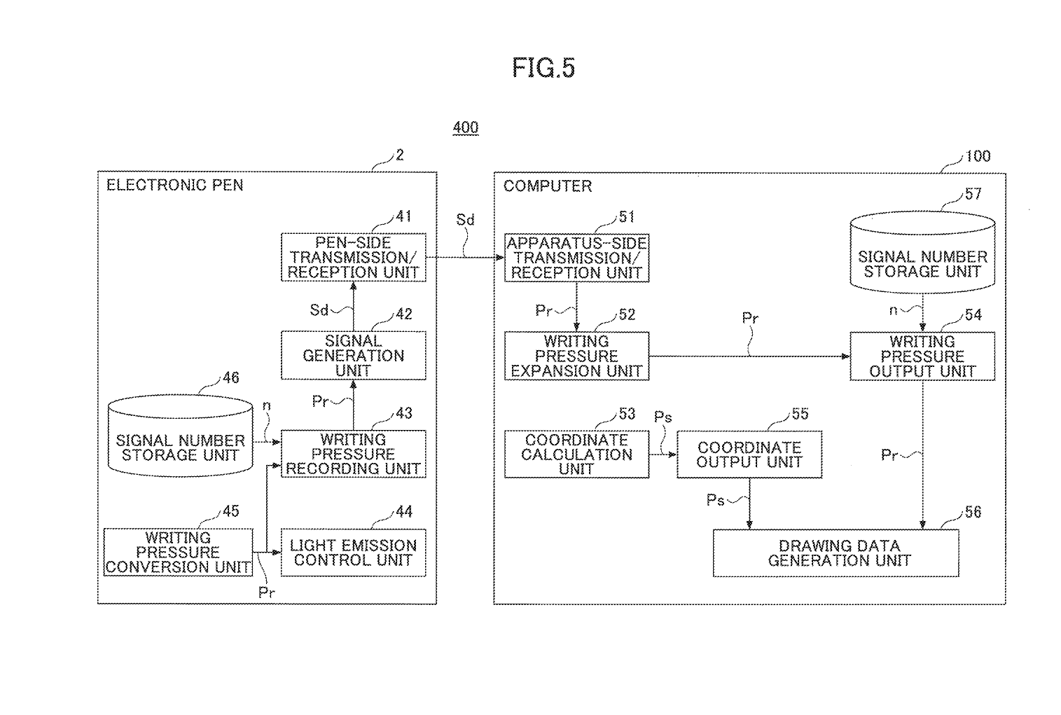

FIG. 5 is a functional block diagram illustrating an example of the drawing system 400 including the electronic pen 2 and the computer 100. The electronic pen 2 includes a writing pressure conversion unit 45, a signal generation unit 42, a writing pressure recording unit 43, a light emission control unit 44, a pen-side transmission/reception unit 41 and a signal number storage unit 46. The signal number storage unit 46 is in a storage device such as the ROM 28 or the RAM 27, and stores a number of signals of writing pressure information which the electronic pen 2 sends in one transmission. The numbers of signals n stored in the signal number storage unit 46 and in a signal number storage unit 57 in the computer 100 are the same. Therefore, the computer 100 preferably sends the number of signals n to the electronic pen 2. The computer 100 sends the number of signals n at a predetermined timing (e.g. upon the computer 100 communicating first with the electronic pen, periodically, or the like). Or, the number of signals n may be stored in the signal number storage unit 46 in advance before shipping of the electronic pen 2.

The writing pressure conversion unit 45 is a function or a means enabled by the CPU 26 executing the program for electronic pen to cooperate with the contact detection unit 22 and the A/D conversion unit 29 of the electronic pen 2. The writing pressure conversion unit 45 converts the writing pressure detected by the contact detection unit 22 into writing pressure information at a predetermined time interval t.

The light emission control unit 44 is a function or a means enabled by the CPU 26 executing the program for electronic pen to cooperate with the apical part 21 of the electronic pen 2. The light emission control unit 44 acquires writing pressure information from the writing pressure conversion unit 45 and compares it with a threshold. In a case the writing pressure information is greater than or equal to the threshold, the light emission control unit 44 causes the apical part 21 to emit light, and in a case of being less than the threshold, the light emission control unit 44 does not cause the apical part 21 to emit light (turns of the light).

The writing pressure recording unit 43 is a function of a means enabled by the CPU 26 executing the program for electronic pen to cooperate with the RAM 27. The writing pressure recording unit 43 reads out a number of signals n from the signal number storage unit 46. Moreover, in a case of acquiring the writing pressure information from the writing pressure conversion unit 45, the writing pressure recording unit 43 accumulates the writing pressure information, for example, in the RAM 27 until the number of signals reaches n, and outputs the writing pressure information of the number of signals n to the signal generation unit 42 at a time interval t.

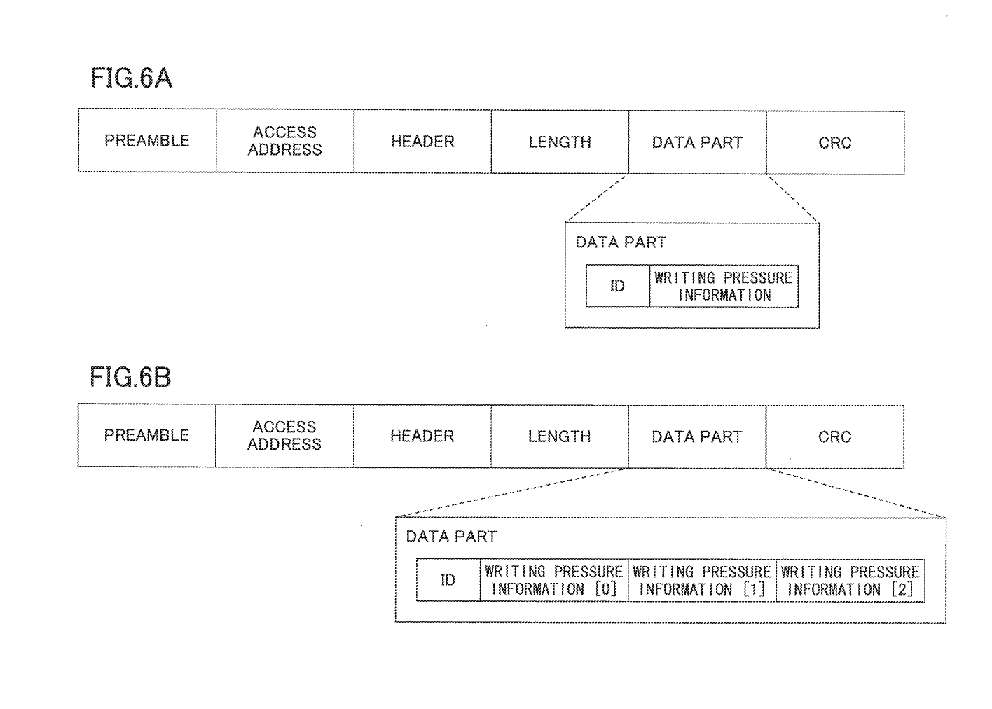

The signal generation unit 42 is a function or a means enabled by the CPU 26 executing the program for electronic pen. The signal generation unit 42 stores the writing pressure information of the number of signals n, for example, into a packet format of Bluetooth, and outputs it to the pen-side transmission/reception unit 41. Details will be described with reference to FIGS. 6A and 6B. Information sent from the electronic pen to the electronic whiteboard will be referred to as transmission data Sd.

The pen-side transmission/reception unit 41 is a function or a means enabled by the CPU 26 executing the program for electronic pen to cooperate with the wireless notification unit 23. The pen-side transmission/reception unit 41 sends the transmission data Sd including n pieces of writing pressure information to the electronic whiteboard 300 in one transmission.

Next, functions of the computer 100 will be described. The computer 100 includes an apparatus-side transmission/reception unit 51, a writing pressure expansion unit 52, a writing pressure output unit 54, a coordinate calculation unit 53, a coordinate output unit 55, a drawing data generation unit 56 and a signal number storage unit 57. The signal number storage unit 57 is in a storage device such as the SSD 104, the ROM 102 or the RAM 103 of the computer 100, and stores a number of signals n of the writing pressure information that the electronic pen 2 sends in one transmission. The number of signals n stored in the signal number storage unit 57 may be stored before shipping in advance, or a user may set the number of signals n using the display device 200 as a user interface. Moreover, a server or the like may set the number of signals n via a network.

The apparatus-side transmission/reception unit 51 is a function or a means enabled by the CPU 101 of the computer 100 executing the program for drawing system 119 to cooperate with the electronic pen controller 116. The apparatus-side transmission/reception unit 51 extracts n pieces of writing pressure information Pr collectively from the transmission data, and outputs them to the writing pressure expansion unit 52.

The writing pressure expansion unit 52 is a function or a means enabled by the CPU 101 executing the program for drawing system 119. The writing pressure information expansion unit 52 expands the n pieces of writing pressure information. The expansion refers to extracting the n pieces of writing pressure information in time series and generating separated pieces of writing pressure information Pr one by one. Meanwhile, the writing pressure expansion unit 52 is an example of a physical quantity extraction unit.

The writing pressure output unit 54 is a function or a means enabled by the CPU 101 executing the program for drawing system 119. The writing pressure output unit 54 sends writing pressure information Pr to the drawing data generation unit 56 at a predetermined time interval t. Therefore, in the same way as in the case where pieces of writing pressure information are sent from the electronic pen 2 one by one, the pieces of writing pressure information are input to the drawing data generation unit 56 one by one.

The coordinate calculation unit 53 is a function or a means enabled by the CPU 101 executing the program for drawing system 119 to cooperate with the imaging unit 32. The coordinate calculation unit 53 calculates a coordinate set Ps of the light emitting part of the same electronic pen 2 captured by the two imaging units 32 on the principle of triangulation, and outputs it to the coordinate output unit 55. Specifically, for example, from a position of the light emitting part in a horizontal direction in an image captured by the imaging unit 32a, a direction of the electronic pen 2 viewed from the imaging unit 32 can be obtained. Similarly, a direction of the electronic pen 2 viewed from the imaging unit 32b also can be obtained. A position at which the two directions cross is the coordinate set of the electronic pen 2. Meanwhile, the coordinate calculation unit 53 repeatedly calculates the coordinate set Ps in a predetermined cycle.

The coordinate output unit 55 is a function or a means enabled by the CPU 101 executing the program for drawing system 119. The coordinate output unit 55 serially outputs the coordinates Ps calculated by the coordinate calculation unit 53 to the drawing data generation unit 56.

The drawing data generation unit 56 is a function or a means enabled by the CPU 101 executing the program for drawing system 119. The drawing data generation unit 56 generates drawing data of a line connecting the coordinates output by the coordinate output unit 55 in time series. Then, a thickness of the line in this case is adjusted based on the writing pressure information Pr output by the writing pressure output unit 54. For example, the thickness is calculated according a formula:

Thickness=(coefficient)×(writing pressure information)×(thickness as a base),

and generates drawing data of a line which becomes thicker as the writing pressure information increases and becomes thinner as the writing pressure information decreases. The coefficient is a constant or a variable for converting writing pressure information into a thickness.

Meanwhile, the acquisition of the coordinate set and the reception of the writing pressure information are not necessarily performed at the same timing. However, in the first embodiment, the acquisition of the coordinate set and the reception of the writing pressure information are assumed to be performed within a negligible time difference. Moreover, the frequency of acquiring the coordinate set is not necessarily the same as the frequency of acquiring the writing pressure information. In a case where the frequency of acquiring coordinate set is greater than the frequency of acquiring writing pressure information, the computer 100 compensates for the writing pressure information by associating a piece of writing pressure information with two coordinate sets or the like. In a case where the frequency of acquiring coordinate sets is less than the frequency of acquiring writing pressure information, the computer 100 calculates an average of pieces of writing pressure information or the like and associates the average with one coordinate set.

<<Transmission Data>>

An upper part of FIG. 6A is a diagram for schematically explaining an example of a packet format of the transmission data. The transmission data in FIG. 6A is, for example, compliant with the standard of Bluetooth (trademark registered) LE. The transmission data includes mainly a preamble, an access address, a header, a length, a data part and a CRC.

Meanwhile, in Bluetooth (trademark registered) LE, the electronic pen 2 and the computer 100 can communicate with each other without performing pairing. Therefore, each of a plurality of electronic pens 2 can communicate with the computer 100 only by entering a communication range of the computer 100.

The preamble is an eight bit signal used for synchronization to report from the transmission side to the reception side that transmission data are to be transmitted. The access address is a random 32-bit signal used on the transmission side and on the reception side upon communicating. The header indicates a type of transmission data, and is an eight bit signal reporting discovery and connection of a device, connection request or the like from the transmission side to the reception side. The length is an eight bit signal indicating a length of the data part. The data part is a signal having 16 to 624 bits (2 to 39 bytes) storing information to be transmitted (e.g. writing pressure information). The CRC is a 24-bit signal of an error-correcting code. In the first embodiment, the data from the preamble to the CRC will be explained as a transmission datum sent in one transmission.

A lower part of FIG. 6A shows a data part of a transmission datum including a piece of writing pressure information. In FIG. 6A, an ID and a piece of writing pressure information are sent by the transmission datum. Meanwhile, the piece of writing pressure information has a size of about 16 bits (2 bytes).

An upper part of FIG. 6B shows a packet format of transmission data and a lower part of FIG. 6B shows a data part of a transmission datum including three pieces of writing pressure information. In the lower part of FIG. 6B, an ID and three pieces of writing pressure information are sent by a transmission datum. As shown in FIGS. 6A and 6B, in the data part, from a head of a signal, an ID and pieces of writing pressure information [0] to [2] are stored in time series continuously. Meanwhile, it is assumed that the closer to the ID the piece of writing pressure information is arranged, the older the piece of writing pressure information is. But, it may be assumed that the closer to the ID the piece of writing pressure information is arranged, the newer the piece of writing pressure information is.

Since the maximum size of the data part is 624 bits (39 bytes), without including ID, 19 pieces of comparison information can be stored at the maximum.

By storing pieces of writing pressure information continuously, an overall size of the transmission data can be made small. Accordingly, the following effects are obtained.

1. Since the transmission time can be shortened, the power consumption can be reduced.
2. Since an ID and a piece of writing pressure information are read out in sequence from the head of the data part, a load of the expansion process for the writing pressure can be reduced.

Meanwhile, the signal generation unit 42 may form the data part not only with pieces of writing pressure information but also by attaching an acquisition time to each piece of writing pressure information. Moreover, the signal generation unit 42 may form the data part attaching the acquisition time to the piece of writing pressure information at the head and attaching a time interval t to each piece of the writing pressure information.

Moreover, FIGS. 6A and 6B are diagrams illustrating examples of transmission data in which the writing pressure information is sent. The contact signal/non-contact signal or the ON information is appropriately sent separately from the writing pressure information. Meanwhile, the transmission datum may include different information. The type of information included in the data part may be distinguished on the reception side by bit strings on the head of the writing pressure information, the contact signal/non-contact signal and the ON information, for example. Or, information indicated for identifying the writing pressure information, the contact signal/non-contact signal and the ON information may be added by the transmission side.

FIGS. 6A and 6B show the packet formats of the Bluetooth (trademark registered) LE. Also in a case of sending transmission data via a communication of infrared light, a wireless LAN, ultrasonic waves or visible light, a plurality of pieces of writing pressure information are sent in a transmission datum in the same way as above.

<Operation Procedure>

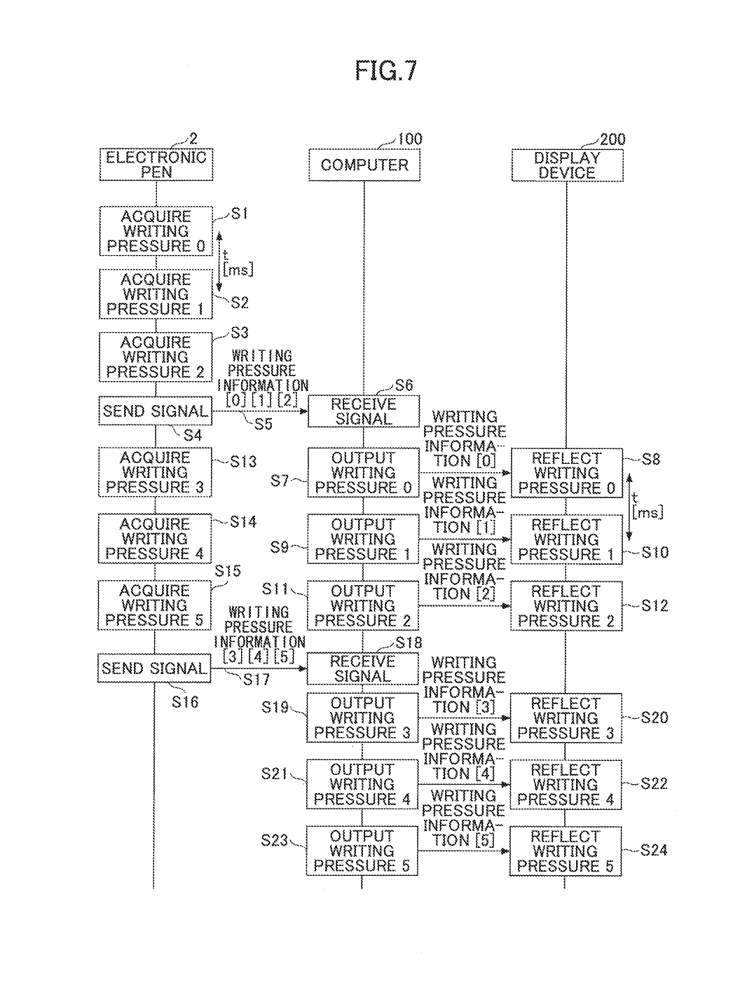

FIG. 7 is a sequence diagram illustrating an example of a procedure of sending transmission data to the computer 100 by the electronic pen 2 according to the first embodiment. In FIG. 7, the process starts in a case where the electronic pen 2 becomes capable of acquiring writing pressure and the computer 100 becomes capable of receiving the transmission data.

The contact detection unit 22 of the electronic pen 2 performs acquisition of writing pressure n times at a time interval t ms (step S1). First, the contact detection unit 22 acquires writing pressure [0]. In FIG. 3, the number of signals n is “three”.

The contact detection unit 22 acquires writing pressure [1] after the time interval t (step S2).

The contact detection unit 22 acquires writing pressure [2] after the time interval t (step S3).

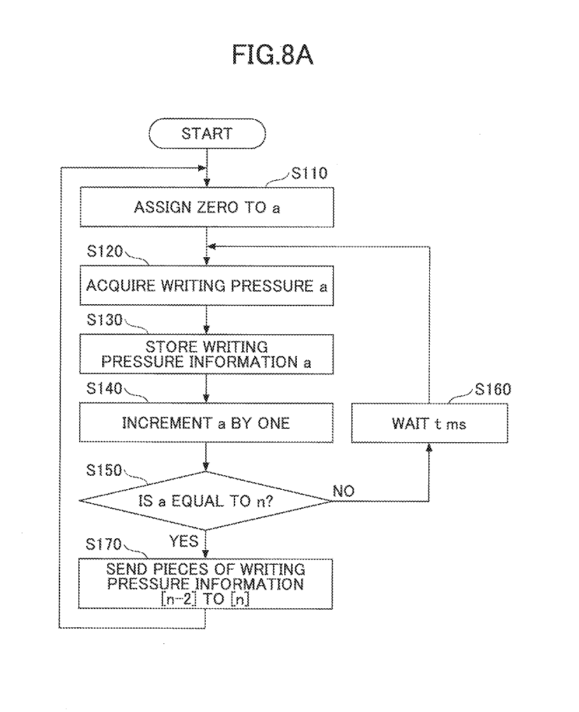

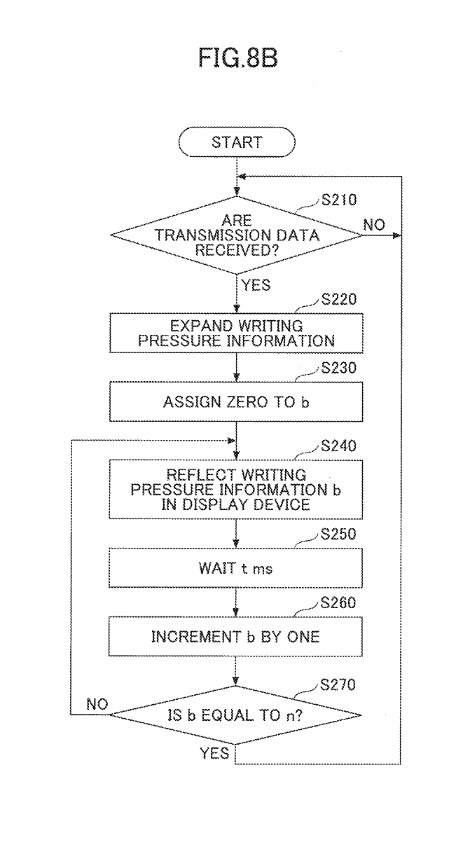

The writing pressure conversion unit 45 converts the acquired writing pressures in order from the oldest to the newest into a piece of writing pressure information [0], a piece of writing pressure information [1] and a piece of writing pressure information [2] (step S4). The writing pressure recording unit 43 records the three pieces of writing pressure information. The signal generation unit 42 generates transmission data including the three pieces of writing pressure information. Meanwhile, the process of the electronic pen 2 will be described in detail with reference to FIG. 8A.

The pen-side transmission/reception unit 41 of the electronic pen 2 sends the transmission data including the piece of writing pressure information [0], the piece of writing pressure information [1] and the piece of writing pressure information [2] to the computer 100 (step S5).

The apparatus-side transmission/reception unit 51 of the computer 100 receives the transmission data (step S6). The writing pressure expansion unit 52 of the computer 100 expands the piece of writing pressure information [0], the piece of writing pressure information [1] and the piece of writing pressure information [2] in time series.

Next, the writing pressure output unit 54 of the computer 100 outputs the writing pressure information [0] to the drawing data generation unit 56 (step S7).

Therefore, the drawing data generation unit 56 draws a line reflecting the piece of writing pressure information [0] at a coordinate set on the display device 200 where the electronic pen 2 exists (step S8).

Next, the writing pressure output unit 54 of the computer 100, after the time interval t has elapsed, outputs the writing pressure information [1] to the drawing data generation unit 56 (step S9).

Therefore, the drawing data generation unit 56 draws a line reflecting the piece of writing pressure information [1] at a coordinate set on the display device 200 where the electronic pen 2 exists (step S10).

Next, the writing pressure output unit 54 of the computer 100, after the time interval t has elapsed, outputs the writing pressure information [2] to the drawing data generation unit 56 (step S11).

Therefore, the drawing data generation unit 56 draws a line reflecting the piece of writing pressure information [2] at a coordinate set on the display device 200 where the electronic pen 2 exists (step S12). Meanwhile, the process of the computer 100 will be explained in detail with reference to FIG. 8B.

The above process is performed for the pieces of writing pressure information [3] to [5] in the same way as above.

The contact detection unit 22 acquires writing pressure [3] in parallel with the process of sending the writing pressure information [0], the writing pressure information [1] and the writing pressure information [2] in step S4 (step S13).

The contact detection unit 22 acquires writing pressure [4] after the time interval t (step S14).

The contact detection unit 22 acquires writing pressure [5] after the time interval t (step S15).

The writing pressure conversion unit 45 converts the acquired writing pressures in order from the oldest to the newest into a piece of writing pressure information [3], a piece of writing pressure information [4] and a piece of writing pressure information [5] (step S16). The writing pressure recording unit 43 records the three pieces of writing pressure information. The signal generation unit 42 generates transmission data including the three pieces of writing pressure information.

The pen-side transmission/reception unit 41 of the electronic pen 2 sends the transmission data including the piece of writing pressure information [3], the piece of writing pressure information [4] and the piece of writing pressure information [5] to the computer 100 (step S17).

The apparatus-side transmission/reception unit 51 of the computer 100 receives the transmission data (step S18). The writing pressure expansion unit 52 of the computer 100 expands the piece of writing pressure information [3], the piece of writing pressure information [4] and the piece of writing pressure information [5] in time series.

Next, the writing pressure output unit 54 of the computer 100 outputs the writing pressure information [3] to the drawing data generation unit 56 (step S19).

Therefore, the drawing data generation unit 56 draws a line reflecting the piece of writing pressure information [3] at a coordinate set on the display device 200 where the electronic pen 2 exists (step S20).

Next, the writing pressure output unit 54 of the computer 100, after the time interval t has elapsed, outputs the writing pressure information [4] to the drawing data generation unit 56 (step S21).

Therefore, the drawing data generation unit 56 draws a line reflecting the piece of writing pressure information [4] at a coordinate set on the display device 200 where the electronic pen 2 exists (step S22).

Next, the writing pressure output unit 54 of the computer 100, after the time interval t has elapsed, outputs the writing pressure information [5] to the drawing data generation unit 56 (step S23).

Therefore, the drawing data generation unit 56 draws a line reflecting the piece of writing pressure information [5] at a coordinate set on the display device 200 where the electronic pen 2 exists (step S24).

The electronic pen 2 and the computer 100 perform the above-described process repeatedly.

FIG. 8A is a flowchart illustrating an example of a procedure of the electronic pen 2 sending the transmission data according to the first embodiment.

In a case where the electronic pen 2 becomes able to acquire writing pressure information, the writing pressure recording unit 43 initializes a variable “a” (step S110). Here, the variable “a” is assumed to be set zero by the initialization.

The contact detection unit 22 of the electronic pen 2 detects writing pressure [a] (step S120).

The writing pressure generation unit 45 performs an A/D conversion or the like for the writing pressure detected in step S120, to obtain writing pressure information [a] (step S130). The writing pressure recording unit 43 records the writing pressure information [a].

Next, the writing pressure recording unit 43 increments the variable “a” by one (step S140).

The writing pressure recording unit 43 determines whether the variable “a” coincides with the number of signals n which is stored in the signal number storage unit 46 (step S150).

In a case where the variable “a” is different from the number of signals n (step S150: NO), the writing pressure conversion unit 45 waits t ms (step S160). Then, the process returns to step S120, and next writing pressure is acquired.

In a case where the variable “a” is equal to the number of signals n (step S150: YES), the signal generation unit 42 generates transmission data including writing pressure information [n−2] to writing pressure [n], and the pen-side transmission/reception unit 41 sends the transmission data to the computer 100 (step S170). The process returns to step S110 thereafter, and next three pieces of writing pressure information are acquired.

FIG. 8B is a flowchart illustrating an example of a procedure of the computer 100 receiving transmission data according to the first embodiment.

The apparatus-side transmission/reception unit 51 determines whether the transmission data are received (step S210). In a case where the transmission data are not received, the apparatus-side transmission/reception unit 51 waits until the transmission data are received.

In a case where the transmission data are received (step S210: YES), the writing pressure expansion unit 52 expands three pieces of writing pressure information [n−2] to writing pressure [n] (step S220).

The writing pressure output unit 54 initializes a counter “b” (step S230). Here, the counter “b” is assumed to be set zero by the initialization.

The writing pressure output unit 54 outputs writing pressure information [b], and the drawing data generation unit 56 outputs drawing data in which the writing pressure information [b] is reflected to a coordinate set output by the coordinate output unit 55 (step S240).

The writing pressure output unit 54 waits the time interval t ms (step S250).

The writing pressure output unit 54 increments the counter “b” by one (step S260).

Then, the writing pressure output unit 54 determines whether the counter “b” coincides with the number of signals n (step S270).

In a case where the counter “b” is different from the number of signals n (step S270: NO), the process returns to step S240. In a case where the counter “b” is equal to the number of signals n (step S270: YES), the process returns to step S210, and the computer 100 waits until the transmission source is received.

As described above, since the drawing system 400 according to the first embodiment can send n pieces of writing pressure information in a transmission datum, the need for increasing a transmission frequency in a case of increasing an amount of information to be sent to the computer 100 can be reduced. For example, assume that the transmission frequency for transmission data (“A” Hz, i.e. sending a transmission datum every 1/A seconds) is required to be increased by three times in order to send writing pressure information. In a case of a transmission frequency of A×3 Hz, an interference may occur. That is, an interference can occur in a case where a device, such as Bluetooth (trademark registered) or a wireless LAN, communicating with a frequency band which is close to that of the electronic pen 2 exists around the electronic pen 2. On the other hand, the drawing system 400 according to the first embodiment can send information having three times the amount of the information while maintaining the transmission frequency of “A” Hz.

Moreover, in a case where it becomes difficult to send transmission data in the transmission frequency of “A” Hz due to increasing the number of the above-described devices around the electronic pen 2, the transmission frequency can be reduced by increasing a number of signals n included in a transmission datum. Therefore, even if the transmission frequency is reduced, the amount of information sent to the computer 100 is not reduced. Moreover, since the transmission frequency is reduced, the power consumption of the electronic pen 2 can be suppressed.

### Second Embodiment

In a second embodiment, a drawing system 400 in which a number of signals n can be changed will be described. In the specification of the present application, a member to which the same reference numeral is assigned serves the same function, an explanation for the member once explained may be omitted or only a difference may be explained.

As described in the first embodiment, in the case of sending n pieces of writing pressure information in one transmission, a lot of benefits are obtained. However, in a case of increasing the number of signals n, a time difference between the input of a coordinate set by a user using the electronic pen 2 and the reception of writing pressure information by the electronic whiteboard 300 tends to increase. Therefore, the electronic pen 2 preferably sends transmission data by increasing the transmission frequency with a small number of signals n.

Then, in the second embodiment, the drawing system 400, which determines presence or absence of interference, makes the number of signals n as small as possible and the transmission frequency as great as possible, will be explained.

<Regarding Function>

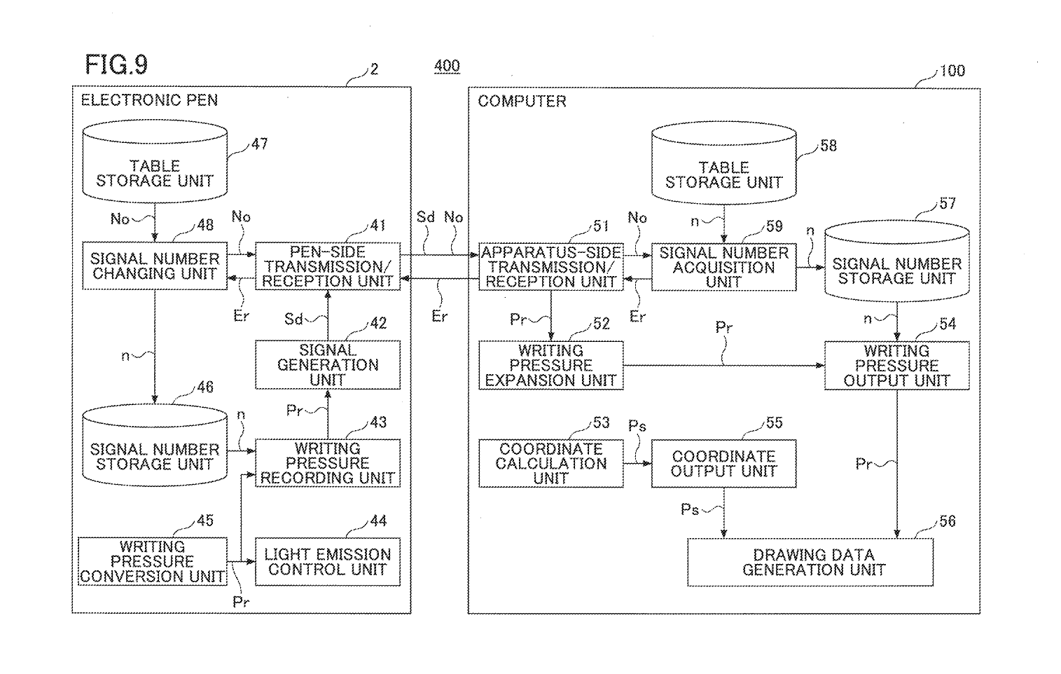

FIG. 9 is a functional block diagram illustrating an example of the drawing system 400 having the electronic pen 2 and the computer 100 according to the second embodiment. The electronic pen 2 according to the second embodiment further includes a signal number changing unit 48 and a table storage unit 47. The table storage unit 47 is in a storage device such as the ROM 28 or the RAM 27, and stores a transmission frequency/signal number table, as shown in TABLE 1.

TABLE 1

| Record | Transmission | Number of | N [number of |
|---|---|---|---|
| No. | frequency [Hz] | signals n | pieces/second] |
| 1 | 100 | 1 | 100 |
| 2 | 50 | 2 | 100 |
| 3 | 33 | 3 | 99 |
| 4 | 25 | 4 | 100 |
| 5 | 20 | 5 | 100 |
| 6 | 14 | 7 | 98 |
| 7 | 10 | 10 | 100 |

TABLE 1 shows an example of the transmission frequency/signal number table according to the second embodiment. In the transmission frequency/signal number table, the transmission frequency and the number of signals n are associated with each other corresponding to the record number. For convenience of explanation, numbers of pieces of writing pressure information sent per second N [number of pieces/second] are listed. However, the numbers of pieces of writing pressure information sent per second N may not be registered in the transmission frequency/signal number table.

The transmission frequency of the record number 1 is 100 Hz and the number of signals n is 1. Therefore, 100 pieces of writing pressure information are sent in a second. A developer in a manufacturer or the like can determine experimentally the number of pieces of writing pressure information sent in a second N. For example, the developer experimentally searches the number of pieces of writing pressure information received in a second N by the electronic whiteboard 300 which enables a drawing excellent in use feeling for a user. In a case where the number of signals is 1, an experimentally determined value is the transmission frequency.

The transmission frequencies and numbers of signals of the record numbers 2 and after are set so as to obtain the number of pieces of writing pressure information sent in a second N which is obtained experimentally. That is, a product of a transmission frequency and a number of signals is almost constant. Meanwhile, the product is not always required to be almost constant, but the number of pieces of writing pressure information sent in a second may decrease or increase as the number of signals n increases.

Returning to FIG. 9, the explanation continues. The signal number changing unit 48 is a function or a means enabled by the CPU 26 of the electronic pen 2 executing the program for electronic pen. The signal number changing unit 48 notifies the electronic whiteboard 300 of the record number of the number of signals n which is stored in the table storage unit 47 via the pen-side transmission/reception unit 41. For the notification, the record number N in the transmission frequency/signal number table is used. Since the electronic whiteboard 300 also has the same transmission frequency/signal number table, by the record number N, the transmission frequency and the number of signals n can be identified. The signal number changing unit 48 starts sending the transmission data based on, for example, the number of signals n of the record number 1.

Then, the signal number changing unit 48 increases the number of signals n by incrementing the record number in the transmission frequency/signal number table, based on an error notification Er (an example of non-reception information) for transmission data from the electronic whiteboard 300. The signal number changing unit 48 stores the present number of signals n in the signal number storage unit 46.

Next, the computer 100 will be explained. The computer 100 according to the second embodiment further includes a signal number acquisition unit 59 and a table storage unit 58. The table storage unit 58 is in a storage device such as the SSD 104 of the computer 100, the ROM 102 or the RAM 103. The table storage unit 58 of the computer 100 stores a transmission frequency/signal number table of TABLE 1.

The table storage unit 58 may be arranged on a network such as a LAN and downloaded by the computer 100. Moreover, the electronic pen 2 may acquire the transmission frequency/signal number table from the computer 100.

The signal number acquisition unit 59 of the computer 100, in a case of acquiring notification of recording number from the electronic pen 2, reads out the number of signals n associated with the record number from the transmission frequency/signal number table, and stores it in the signal number storage unit 57 of the computer 100. Accordingly, values of the number of signals n held in the electronic pen 2 and in the electronic whiteboard 300 can be maintained the same.

Moreover, the signal number acquisition unit 59 reads out the transmission frequency associated with the record number from the transmission frequency/signal number table, and monitors whether the apparatus-side transmission/reception unit 51 receives transmission data with the transmission frequency. For example, in a case where the apparatus-side transmission/reception unit 51 does not receive transmission data even if the apparatus-side transmission/reception unit 51 waits about twice a reception interval, which is determined by the transmission frequency, it is determined that the transmission data cannot be received. Then, the signal number acquisition unit 59 sends an error notification Er to the electronic pen 2 via the apparatus-side transmission/reception unit 51. Accordingly, the electronic pen 2 can decrease the transmission frequency and increase the number of signals n.

Meanwhile, the signal number acquisition unit 59 may determine that the apparatus-side transmission/reception unit 51 does not receive the transmission data based on a writing pressure number, which will be described in a third embodiment. Since the writing pressure number is a sequential number (it is not required to be a sequential number as long as it increases or decreases regularly) which is sent with the writing pressure information, the signal number acquisition unit 59 can detect that there are transmission data, which are not detected, by monitoring the writing pressure number.

Meanwhile, the computer 100 may download the transmission frequency/signal number table from a network. Moreover, the electronic pen 2 may download the transmission frequency/signal number table from the network, or may acquire the transmission frequency/signal number table from the computer 100.

<Operation Procedure>

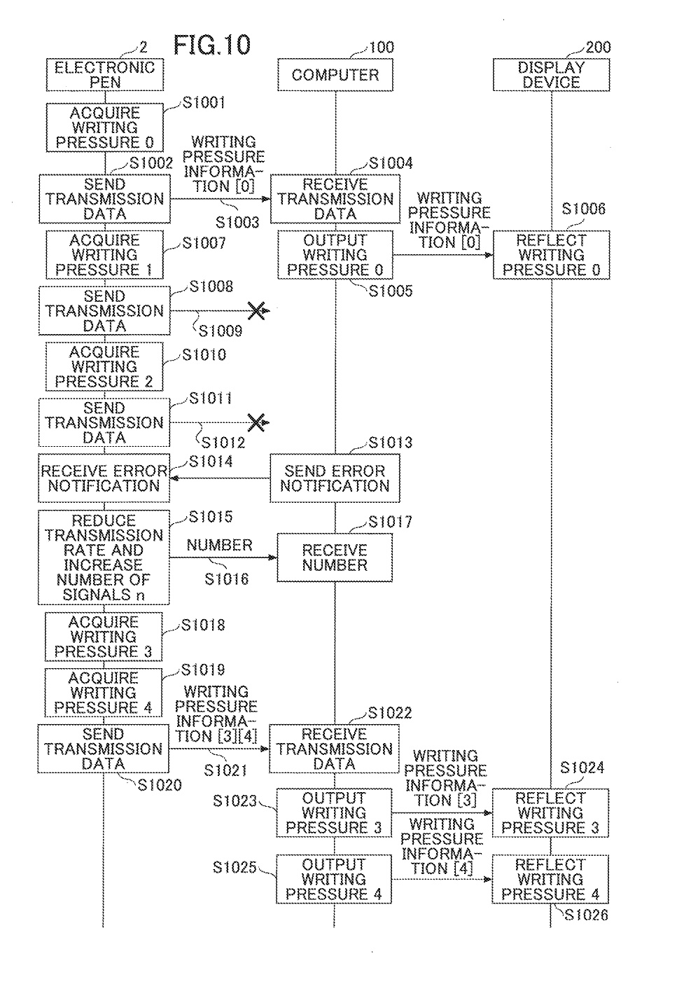

FIG. 10 is a sequence diagram illustrating an example of a procedure of sending transmission data to the computer 100 by the electronic pen 2 according to the second embodiment. In FIG. 10, the process starts in a case where the electronic pen 2 becomes capable of acquiring writing pressure and the computer 100 becomes capable of receiving the transmission data. Meanwhile, an initial transmission frequency is assumed to be 100 Hz and an initial number of signals n is assumed to be “1”.

The contact detection unit 22 acquires writing pressure [0] (step S1001).

The writing pressure conversion unit 45 converts the acquired writing pressure into a piece of writing pressure information [0] (step S1002). The writing pressure recording unit 43 records the piece of writing pressure information [0]. The signal generation unit 42 generates transmission data.

The pen-side transmission/reception unit 41 of the electronic pen 2 sends the transmission data including the piece of writing pressure information [0] to the computer 100 (step S1003).

The apparatus-side transmission/reception unit 51 of the computer 100 receives the transmission data (step S1004). The writing pressure expansion unit 52 of the computer 100 expands the piece of writing pressure information [0].

Next, the writing pressure output unit 54 of the computer 100 outputs the writing pressure information [0] to the drawing data generation unit 56 (step S1005).

Therefore, the drawing data generation unit 56 draws a line reflecting the piece of writing pressure information [0] at a coordinate set on the display device 200 where the electronic pen 2 exists (step S1006).

Next, the contact detection unit 22 acquires writing pressure [1] (step S1007).

The writing pressure conversion unit 45 converts the acquired writing pressure into a piece of writing pressure information [1] (step S1008). The writing pressure recording unit 43 records the piece of writing pressure information [1]. The signal generation unit 42 generates transmission data.

The pen-side transmission/reception unit 41 of the electronic pen 2 sends the transmission data including the piece of writing pressure information [1] to the computer 100 (step S1009). However, the computer 100 cannot receive the transmission data due to an interference or the like.

The contact detection unit 22 acquires writing pressure [2] (step S1010).

The writing pressure conversion unit 45 converts the acquired writing pressure into a piece of writing pressure information [2] (step S1011). The writing pressure recording unit 43 records the piece of writing pressure information [2]. The signal generation unit 42 generates transmission data.

The pen-side transmission/reception unit 41 of the electronic pen 2 sends the transmission data including the piece of writing pressure information [2] to the computer 100 (step S1012). However, the computer 100 cannot receive the transmission data due to an interference or the like.

The signal number acquisition unit 59 of the computer 100 detects that the transmission data cannot be received at a timing of the transmission frequency (step S1013), and sends an error notification to the electronic pen 2.

The pen-side transmission/detection unit 41 of the electronic pen 2 receives the error notification (step S1014).

The signal number changing unit 48 of the electronic pen 2 reduces a transmission rate and increases the number of signals n with reference to the transmission frequency/signal number table (step S1015).

Moreover, the signal number changing unit 48 of the electronic pen 2 notifies the computer 100 of a newly selected record number of the transmission frequency/signal number table (step S1016).

The apparatus-side transmission/reception unit 51 of the computer 100 receives the record number (step S1017), and the signal number acquisition unit 59 acquires the number of signals n from the transmission frequency/signal number table and stores it in the signal number storage unit 57. Accordingly, the numbers of signals n retained in the electronic pen 2 and in the computer 100 coincide with each other.

The contact detection unit 22 acquires writing pressure [3] (step S1018).

The contact detection unit 22 acquires writing pressure [4] after the time interval t (step S1019).

The writing pressure conversion unit 45 converts the acquired writing pressures in order from the oldest to the newest into a piece of writing pressure information [3] and a piece of writing pressure information [4] (step S1020). The writing pressure recording unit 43 records the pieces of writing pressure information. The signal generation unit 42 generates transmission data.

The pen-side transmission/reception unit 41 of the electronic pen 2 sends the transmission data including the piece of writing pressure information [3] and the piece of writing pressure information [4] to the computer 100 (step S1021).

The apparatus-side transmission/reception unit 51 of the computer 100 receives the transmission data (step S1022). The writing pressure expansion unit 52 of the computer 100 expands the piece of writing pressure information [3] and the piece of writing pressure information [4] in time series.

Next, the writing pressure output unit 54 of the computer 100 outputs the writing pressure information [3] to the drawing data generation unit 56 (step S1023).

Therefore, the drawing data generation unit 56 draws a line reflecting the piece of writing pressure information [3] at a coordinate set on the display device 200 where the electronic pen 2 exists (step S1024).

Next, the writing pressure output unit 54 of the computer 100, after the time interval t has elapsed, outputs the writing pressure information [4] to the drawing data generation unit 56 (step S1025).

Therefore, the drawing data generation unit 56 draws a line reflecting the piece of writing pressure information [4] at a coordinate set on the display device 200 where the electronic pen 2 exists (step S1026).

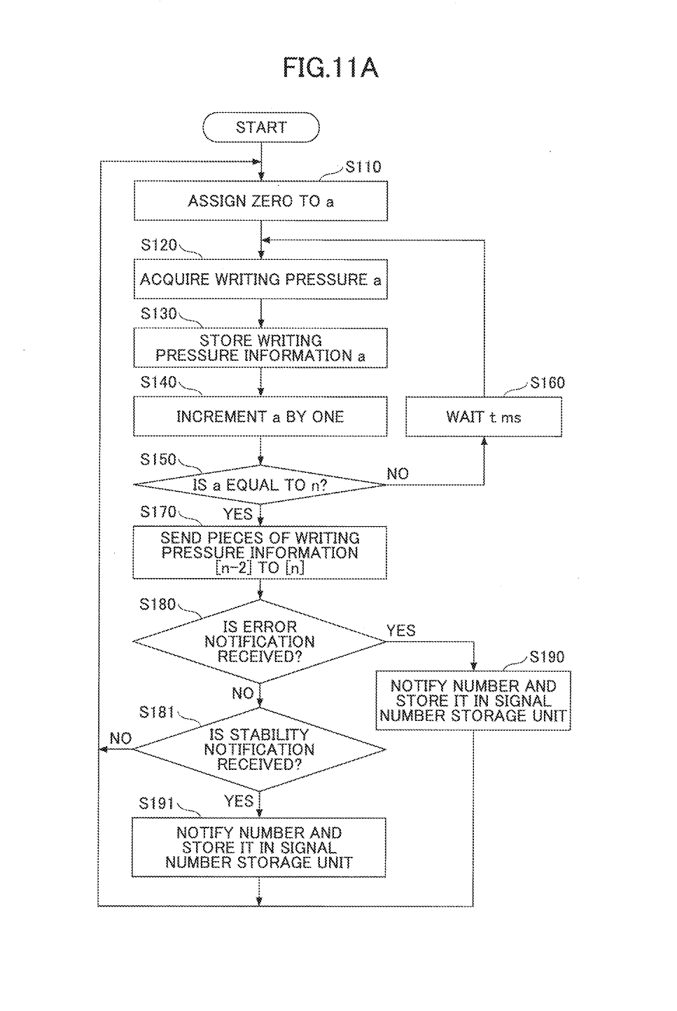

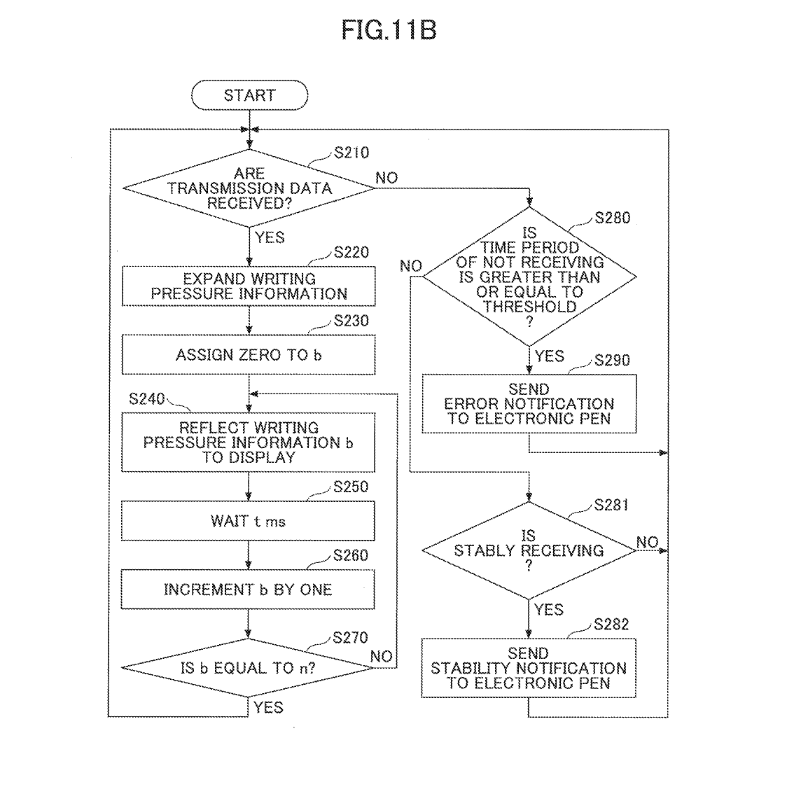

FIG. 11A is a flowchart illustrating an example of a procedure of the electronic pen 2 sending the transmission data according to the second embodiment. FIG. 11A is a flowchart for explaining the processes in steps S1014 and S1015 in FIG. 10. Meanwhile, FIG. 11A is obtained by adding steps S180, S181, S190 and S191 to FIG. 8A. In the following, the processes in steps S180, S181, S190 and S191 will be explained.

After sending the transmission data in step S170, the signal number changing unit 80 of the electronic pen 2 determines whether an error notification is received (step S180). In a case where the error notification is not received (step S180: NO), the process proceeds to step S181.

The signal number changing unit 48 determines whether a stability notification is received (step S181). In a case where the stability notification is not received (step S181: NO), the process returns to step S110. The stability notification will be explained with reference to FIG. 11B.

In a case where the error notification is received (step S180: YES), the signal number changing unit 48 of the electronic pen 2 makes the record number in the transmission frequency/signal number table greater than before by one, and notifies the computer 100 of the record number (step S190). Moreover, the number of signals n is stored in the signal number storage unit 46. Afterwards, the process returns to step S110, and the process of sending transmission data starts with the new number of signals n.

Moreover, in a case where the stability notification is received (step S181: YES), the signal number changing unit 48 of the electronic pen 2 makes the record number in the transmission frequency/signal number table less than before by one, and notifies the computer 100 of the record number (step S191). Moreover, the number of signals n is stored in the signal number storage unit 46. Afterwards, the process returns to step S110, and the process of sending transmission data starts with the new number of signals n.

FIG. 11B is a flowchart illustrating an example of a procedure of the computer 100 receiving the transmission data according to the second embodiment. FIG. 11B is a flowchart for explaining the process in step S1013 in FIG. 10. Meanwhile, FIG. 11B is obtained by adding steps S280, S281, S282 and S290 to FIG. 8B. In the following, the processes in steps S280, S281, S282 and S290 will be explained.

In a case where the apparatus-side transmission/reception unit 51 does not receive the transmission data in step S210, the signal number acquisition unit 59 of the computer 100 determines whether a time period where the transmission data are not received is greater than or equal to a threshold (step S280). The threshold is, for example, about twice an inverse of the present transmission frequency. In a case where the time period is less than the threshold (step S280: NO), the process proceeds to step S281.

Then, in a case where the time period is greater than or equal to the threshold (step S280: YES), the signal number acquisition unit 59 of the computer sends the error notification to the electronic pen 2 (step S290).

Moreover, the signal number acquisition unit 59 of the computer 100 determines whether transmission data are stably received (step S281). Receiving stably means receiving transmission data continuously, for example, from a few times to several tens of times or more. In a case where receiving transmission data is not stable (step S281: NO), the process returns to step S210.

Then, in a case where receiving transmission data is stable (step S281: YES), the signal number acquisition unit of the computer 100 sends a stability notification to the electronic pen (step S282).

In this way, the electronic pen 2 and the computer 100 dynamically change the transmission frequency and the number of signals n. The electronic pen 2 can send writing pressure information with the number of signals n appropriate for present environmental noise to the electronic whiteboard 300. By reducing the transmission frequency in a step-by-step manner, it is possible to send with the greatest transmission frequency that can be sent against the surrounding environmental noise. In a case where the electronic pen 2 can communicate without receiving an error notification, the transmission frequency is increased and the number of signals n is decreased. Therefore, it is possible to send with the greatest transmission frequency that can be sent in an interference state due to surrounding electromagnetic waves.

Meanwhile, in the second embodiment, the transmission of transmission data starts with the transmission frequency of the record number “1” of the transmission frequency/signal number table and the number of signals of 1. However, the transmission of transmission data may start, for example, with the transmission frequency of the record number “3” and the number of signals of 3.

Moreover, in the second embodiment, the electronic pen 2 that receives an error notification determines the transmission frequency and the number of signals n. However, the signal number acquisition unit 59 of the computer 100 may determine the transmission frequency and the number of signals n. That is, the signal number acquisition unit 59 of the computer 100 notifies the electronic pen 2 of the record number of the transmission frequency/signal number table with the error notification. The signal number changing unit 48 of the electronic pen 2 sends transmission data with the transmission frequency and the number of signals n instructed by the record number from the computer 100.

### Third Embodiment

In the case where a plurality of pieces of writing pressure information are sent in a transmission, as shown in the first and second embodiments, the electronic pen 2 can increase an amount of information sent to the electronic whiteboard without increasing the transmission frequency. However, electromagnetic waves can interfere with each other even in a state where the transmission frequency is not increased. In a case where electromagnetic waves interfere with each other, the electronic whiteboard 300 cannot receive all pieces of writing pressure information included in a transmission datum. Therefore, in a case where interference occurs in a state with a great number of signals n, a great number of pieces of writing pressure information are lost.

Then, in the third embodiment, a drawing system that can interpolate writing pressure information in a case where interference occurs will be described. Meanwhile, in the following, “data loss” means that the electronic whiteboard 300 cannot receive transmission data.

<Transmission Data>

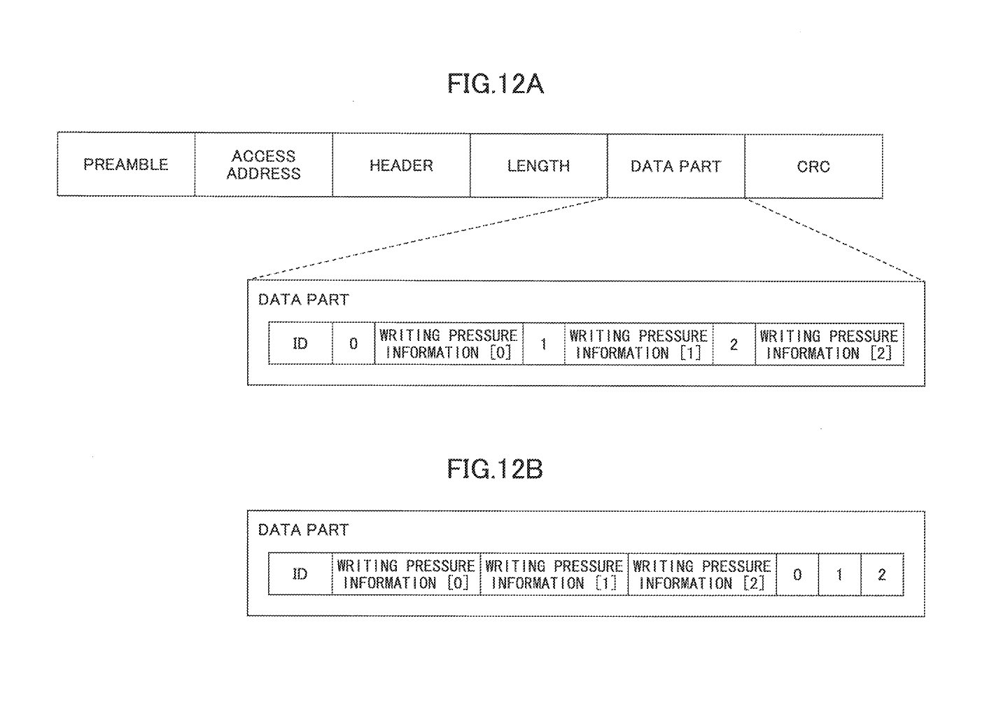

First, with reference to FIGS. 12A and 12B, transmission data according to the third embodiment will be explained. In the third embodiment, in order to detect data loss of writing pressure information by the electronic whiteboard 300, a writing pressure number is attached to a piece of writing pressure information to be sent.

Each of FIGS. 12A and 12B illustrates a data part of a transmission datum including three pieces of writing pressure information. Upper and lower parts of FIG. 12A schematically illustrate a packet format of the transmission datum and n pieces of writing pressure information (In FIGS. 12A and 12B, n is three.) stored in the data part, respectively. In the lower part of FIG. 12A, in the same way as in the lower part of FIG. 6B, an ID and three pieces of writing pressure information are sent in a transmission datum. In the lower part of 12A, a writing pressure number is stored at the head of the respective pieces of writing pressure information. That is, the writing pressure number of the piece of writing pressure information [0] is “0”, the writing pressure number of the piece of writing pressure information [1] is “1” and the writing pressure number of the piece of writing pressure information [2] is “2”. A writing pressure number in a subsequent transmission datum begins with “3”. The writing pressure number is not required to be a sequential number, but by increasing or decreasing regularly in this way, the electronic whiteboard 300 can determine presence or absence of a data loss.

Meanwhile, a site at which the writing pressure number is stored may not be the head of each of the pieces of writing pressure information. For example, as shown in FIG. 12B, the three writing pressure numbers may be stored collectively after the pieces of writing pressure information. That is, the writing pressure numbers “0, 1, 2” are stored after the piece of writing pressure information [2]. Moreover, the writing pressure numbers “0, 1, 2” may be stored between the ID and the piece of writing pressure information [0], or before the ID.

<Regarding Function>

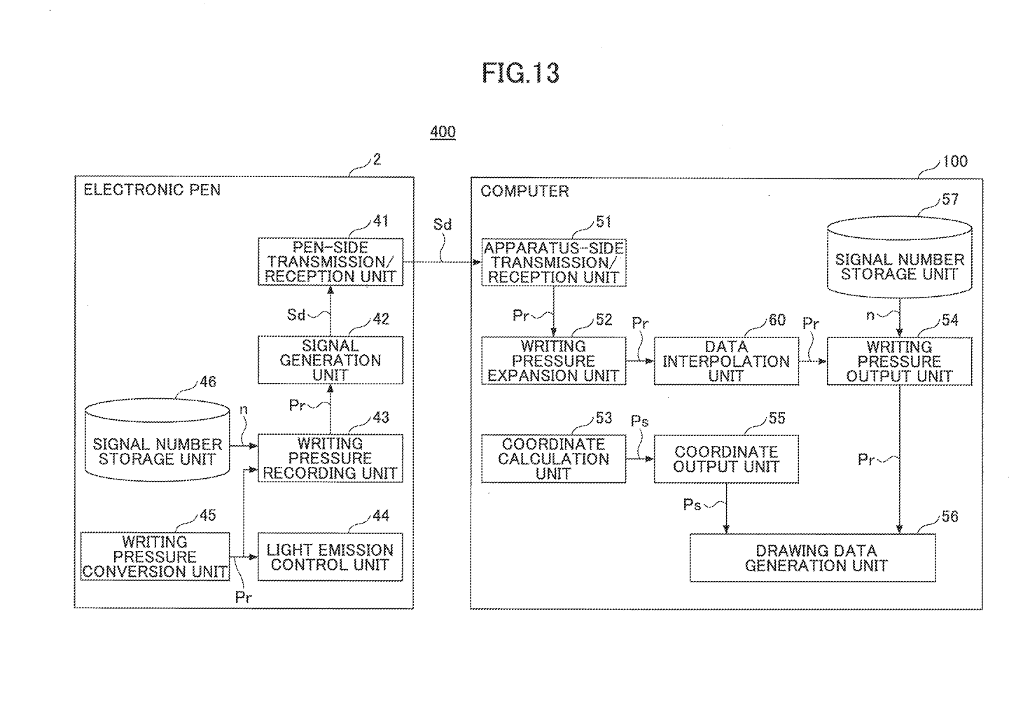

FIG. 13 is a functional block diagram illustrating an example of the drawing system 400 having the electronic pen 2 and the computer 100 according to the third embodiment. In FIG. 13, a member to which the same reference numeral as in FIG. 5 is assigned serves the same function, so only a main member of the third embodiment may be mainly explained.

The electronic pen 2 according to the third embodiment is the same as shown in the functional block diagram of FIG. 5 of the first embodiment. On the other hand, the computer 100 includes a data interpolation unit 60. The data interpolation unit 60 is a function or a means enabled by the CPU 101 executing the program for drawing system. The data interpolation unit 60 retains the writing pressure number which is acquired finally. Then, it is determined whether a writing pressure number, among writing pressure number and writing pressure information expanded by the writing pressure expansion unit 52, has a value to come next after the writing pressure number finally acquired. In a case where the writing pressure number does not have the value to come next, the data interpolation unit 50 interpolates data.

<<Interpolation of Writing Pressure Information>>

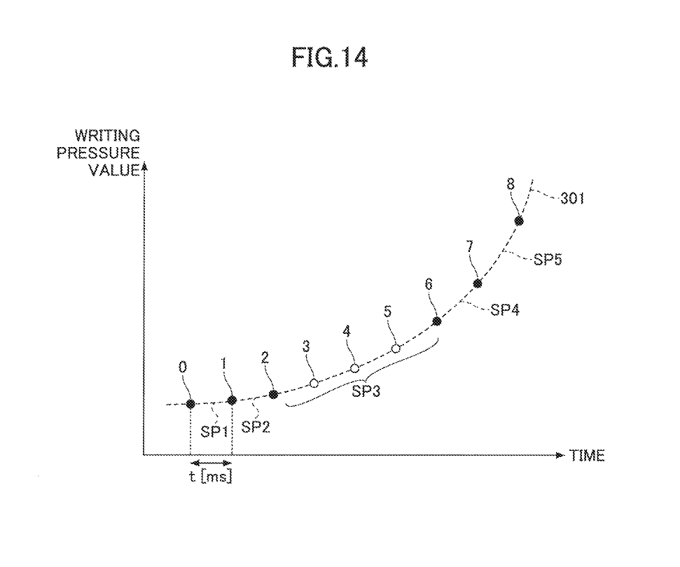

The interpolation of writing pressure information will be explained with reference to FIG. 14. FIG. 14 is a diagram for explaining an example a method of interpolating writing pressure information. In FIG. 14, abscissa and ordinate indicate time and a writing pressure value, respectively. Writing pressures acquired in time series by the electronic pen 2 are associated with time. A black circle represents a writing pressure value where a data loss does not occur and a white circle represents a writing pressure where a data loss occurs. That is, data losses occur for writing pressures “3” to “5”. The data interpolation unit 60 obtains a third order spline curve 301 using at least writing pressures “2” and “6”, which are closest to an interval where data loss occurs, and writing pressures “1” and “7” adjacent to them. Here, writing pressures “0” and “8” are also assumed to be used further in order to improve accuracy in the interpolation. The third order spline curve 301 is obtained based on a policy that both ends of each of five intervals sp1 to sp5 among six coordinates are joined by an independent third order curve, and adjacent intervals are connected smoothly at each of the coordinates. The third order curves are obtained for the five intervals sp1 to sp5, and an object to be interpolated is the interval sp3. Five third order curves each passing through writing pressures at both ends of one of the intervals sp1 to sp5 are obtained.

First, the respective curves are assumed to have the following forms:

y=a₁x³+b₁x²+c₁x+d₁, in sp1;

y=a₂x³+b₂x²+c₂x+d₂, in sp2;

y=a₃x³+b₃x²+c₃x+d₃, in sp3;

y=a₄x³+b₄x²+c₄x+d₄, in sp4; and

y=a₅x³+b₅x²+c₅x+d₅, in sp5;

where x is time and y is a writing pressure value.

Since values of x and y coincide with each other, respectively at a boundary (i.e. writing pressure “0”, “1”, “2”, “6”, “7” or “8”) of adjacent intervals (among sp1 to sp5), simultaneous equations including variables a₁ to a₅, b₁ to b₅, c₁ to c₅ and d₁ to d₅ are obtained. Since there are two boundaries in one equation, ten equations are obtained.

Next, since five curves are connected smoothly at the writing pressures “0”, “1”, “2”, “6”, “7” and “8”, further equations are obtained, i.e. first order derivatives coincide with each other at each of the boundaries and second order derivatives coincide with each other at each of the boundaries. According to the above-described processing, sufficient numbers of simultaneous equations for the numbers of variables, and thereby the variables a₁ to a₅, b₁ to b₅, c₁ to c₅ and d₁ to d₅ can be determined. Therefore, the equation of interval sp3 which is the object for the interpolation, i.e. “y=a₃x³+b₃x²+c₃x+d₃” can be obtained. The data interpolation unit 60 can calculate the writing pressure “3” after the time interval t from the writing pressure “2”, the writing pressure “4” further after the time interval t and the writing pressure “5” further after the time interval t.

Meanwhile, the spline curve may be fourth order or more. The order of the spline curve is determined, for example, taking account of processing power or the like of the computer 100. Moreover, number of employed writing pressure points only has to be enough for determining the variables. The writing pressure “0” or “8” may not be included. Or, the interpolation may be performed using a writing pressure before the writing pressure “0” and a writing pressure after the writing pressure “8”.

Meanwhile, the interpolation for the writing pressure information where the data loss occurs may be performed only using the writing pressure information before the data loss, not using both the writing pressure information before the data loss and the writing pressure information after the data loss, as explained with reference to FIG. 14. That is, the data interpolation unit 60 approximates the pieces of writing pressure information “0” to “2” as a line or a curve by using the least square method or the like. The line or the curve is extrapolated to a range including the writing pressure “3” after the time interval t from the writing pressure “2”, the writing pressure “4” further after the time interval t and the writing pressure “5” further after the time interval t, thereby the writing pressures “3”, “4” and “5” can be calculated.

In this method, the accuracy of the interpolated writing pressure information can be degraded. However, since only past writing pressures are used for the interpolation, the data interpolation unit 60 can estimate writing pressure information before determining presence or absence of data loss. Therefore, it is possible to reflect writing pressure information in drawing data at almost the same timing as in the case where data loss does not occur. In a case where it is found that data loss does not occur as a result of determining presence or absence of data loss, the interpolated writing pressure information may be discarded.

<Regarding Reflection of Writing Pressure Information to Drawing Data>

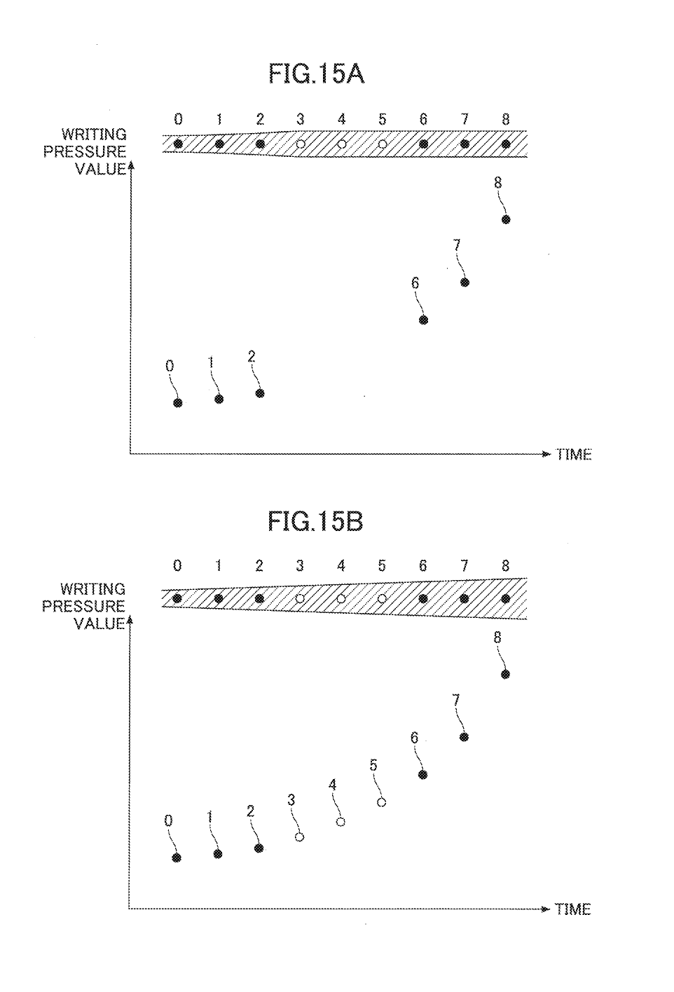

FIGS. 15A and 15B are diagrams for explaining reflection of writing pressure information to drawing data. Assume that a user inputs coordinates lineally with the electronic pen 2, for example. Moreover, it is assumed that for the purpose of explanation, a frequency of acquiring coordinates is the same as a frequency of acquiring pieces of writing pressure information, and a piece of writing pressure information is associated with a coordinate.

FIG. 15A shows coordinates “0” to “8”. The electronic pen 2 sends pieces of writing pressure information to the electronic whiteboard 300 three by three. It is assumed that data loss occurs for pieces of writing pressure information “3” to “5”. In a case where the electronic whiteboard 300 detects the data loss for the pieces of writing pressure information “3” to “5”, it is considered that drawing has been performed at around the eighth coordinate. The writing pressure information is not reflected at least at the coordinates “3” to “5”. It depends on logic of drawing or the like whether the writing pressure information is reflected at the coordinates “6” to “8”. In FIG. 15A, it is assumed that the writing pressure information is not reflected at the coordinates “6” to “8”.

Therefore, the drawing data generation unit 56 of the computer 100 reflects, for example, a thickness as a base to a thickness of a line of the coordinates “3” to “5”, or reflects the writing pressure information, which is reflected at the coordinates “0” to “2”, and draws the line.

Then, as shown in FIG. 15B, in a case where the pieces of writing pressure information “3” to “5” of the coordinates “3” to “5” are interpolated, the drawing data generation unit 56 reflects the interpolated pieces of writing pressure information “3” to “5” at the coordinates “3” to “5”. In this way, as soon as the pieces of writing pressure information are interpolated, the drawing data generation unit 56 reflects the writing pressure information at drawing data, thereby the writing pressure is reflected at a line with a small delay from the drawing of the line. Accordingly, the electronic whiteboard 300 can perform drawing with which a user does not feel uncomfortable.

<Operation Procedure>

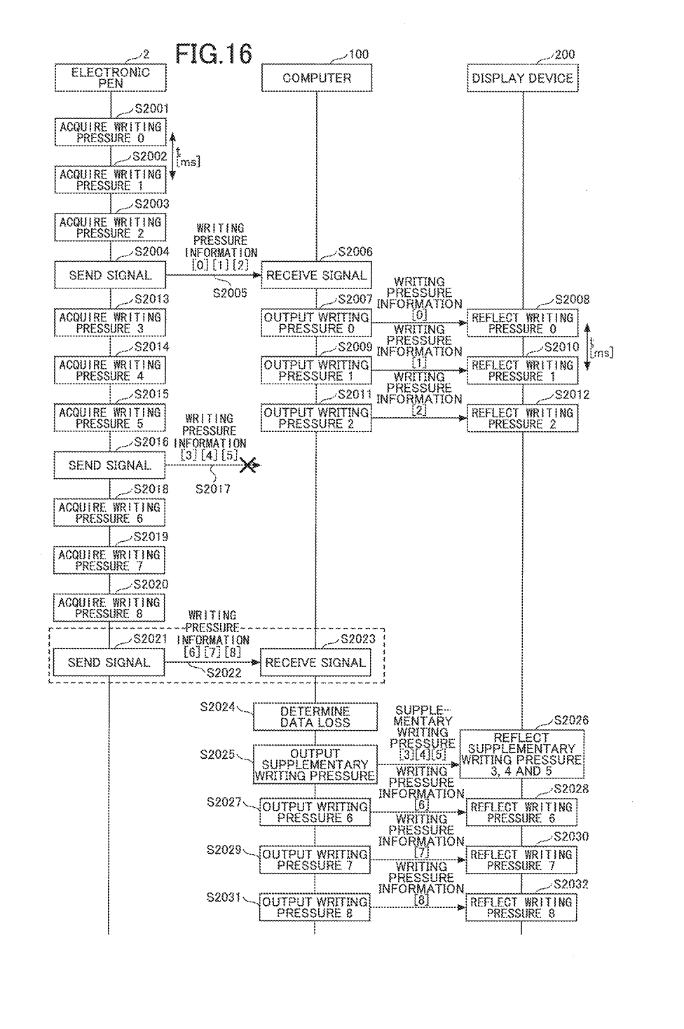

FIG. 16 is a sequence diagram illustrating an example of a procedure of sending transmission data to the computer 100 by the electronic pen 2 according to the third embodiment. In FIG. 16, in step S2017 data loss occurs for the pieces of writing pressure information [3] to [5], and in the next transmission timing the electronic pen 2 sends the pieces of writing pressure information [6] to [8] to the computer 100. Since the procedure until the transmission of the pieces of writing pressure information [3] to [5] (step S2017) is the same as that in FIG. 7, in the following the procedure of sending the pieces of writing pressure information [6] to [8] and later will be explained.

The contact detection unit 22 acquires writing pressure [6] in parallel with the process of sending the writing pressure information [3], the writing pressure information [4] and the writing pressure information [5] in step S2017 (step S2018).

The contact detection unit 22 acquires writing pressure [7] after the time interval t (step S2019).

The contact detection unit 22 acquires writing pressure [8] after the time interval t (step S2020).

The writing pressure conversion unit 45 converts the acquired writing pressures in order from the oldest to the newest into a piece of writing pressure information [6], a piece of writing pressure information [7] and a piece of writing pressure information [8] (step S2021). The writing pressure recording unit 43 records the pieces of writing pressure information. The signal generation unit 42 generates transmission data.

The pen-side transmission/reception unit 41 of the electronic pen 2 sends the transmission data including the piece of writing pressure information [6], the piece of writing pressure information [7] and the piece of writing pressure information [8] to the computer 100 (step S2022).

The apparatus-side transmission/reception unit 51 of the computer 100 receives the transmission data (step S2023). The writing pressure expansion unit 52 of the computer 100 expands the piece of writing pressure information [6], the piece of writing pressure information [7] and the piece of writing pressure information [8] in time series.

Next, the writing pressure expansion unit 52 of the computer 100 outputs the piece of writing pressure information [6], the piece of writing pressure information [7] and the piece of writing pressure information [8] to the data interpolation unit 60.

The data interpolation unit 60 determines whether data loss occurs (step S2024). Here, since pieces of writing pressure information [3] to [5] are not received, it is determined that data loss occurs.

The data interpolation unit 60 interpolates the pieces of writing pressure information [3] to [5] using the pieces of writing pressure information [0] to [2] and the pieces of writing pressure information [8] to [8] (step S2025). The data interpolation unit 60 that interpolates the pieces of writing pressure information [3] to [5] sends the pieces of writing pressure information [3] to [5] to the writing pressure output unit 54.

Therefore, the drawing data generation unit 56 reflects the pieces of writing pressure information [3] to [5] onto a thickness of a line already drawn in the display device 200 (step S2026).

Next, the writing pressure output unit 54 of the computer 100, after the time interval t has elapsed, outputs the writing pressure information [6] to the drawing data generation unit 56 (step S2027).

Therefore, the drawing data generation unit 56 draws a line reflecting the piece of writing pressure information [6] at a coordinate set on the display device 200 where the electronic pen 2 exists (step S2028).

Next, the writing pressure output unit 54 of the computer 100, after the time interval t has elapsed, outputs the writing pressure information [7] to the drawing data generation unit 56 (step S2029).

Therefore, the drawing data generation unit 56 draws a line reflecting the piece of writing pressure information [7] at a coordinate set on the display device 200 where the electronic pen 2 exists (step S2030).

Next, the writing pressure output unit 54 of the computer 100, after the time interval t has elapsed, outputs the writing pressure information [8] to the drawing data generation unit 56 (step S2031).

Therefore, the drawing data generation unit 56 draws a line reflecting the piece of writing pressure information [8] at a coordinate set on the display device 200 where the electronic pen 2 exists (step S2032).

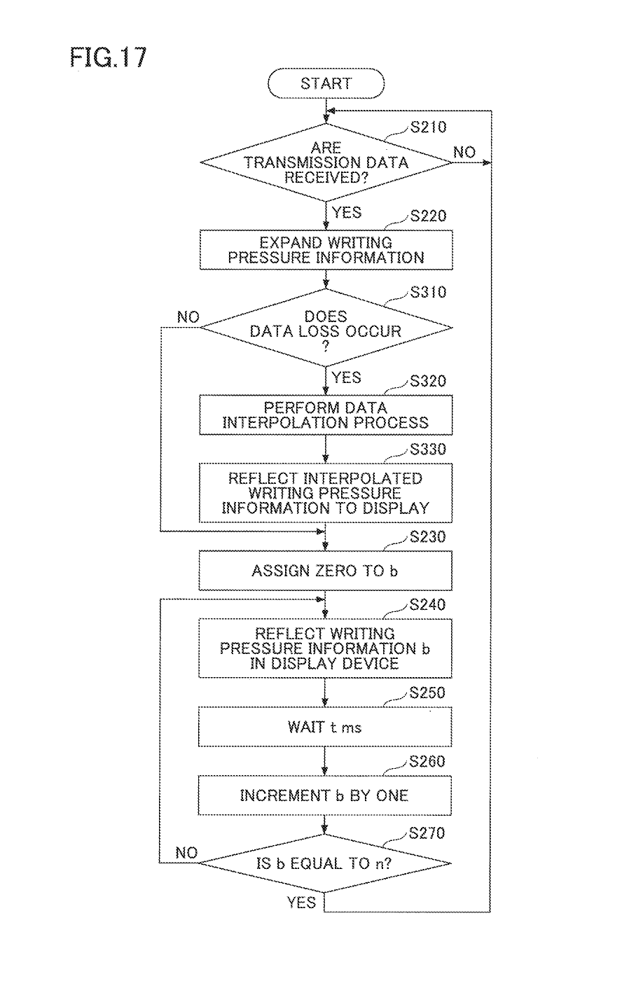

FIG. 17 is a flowchart illustrating an example of a procedure of the computer 100 receiving the transmission data according to the third embodiment. The procedure of the electronic pen 2 sending the transmission data is the same as in FIG. 8A, and illustration will be omitted. Meanwhile, FIG. 17 is obtained by adding steps S310 to S330 to FIG. 8B. In the following, the processes in steps S310 to S330 will be explained.

In a case where the pieces of writing pressure information expanded in step S220, the data interpolation unit 60 determines whether data loss occurs (step S310). In a case where data loss does not occur (step S310: NO), the process in step S230 and later will be executed as in the first embodiment.

In a case where the data loss occurs (step S310: YES), the data interpolation unit 60 interpolates the pieces of writing pressure information (step S320).

Then, the writing pressure output unit 54 outputs the pieces of writing pressure information obtained by the interpolation to the drawing data generation unit 56, and thereby the drawing data generation unit 56 reflects the interpolated pieces of writing pressure information onto the line in the display device 200 (step S330).

Afterwards, the process returns to step S230, and the process for a piece of writing pressure information that is finally received is performed.

As described above, according to the third embodiment, since pieces of writing pressure information where data loss occurs are interpolated, it is possible to reflect the pieces of writing pressure information where data loss occurs in drawing data even if a plurality of pieces of writing pressure information are sent in one transmission.

In a case where a time for a stroke is short and an amount of writing pressure information corresponding to the same stroke is small, such as a line on a Chinese character (KANJI), due to few clues it is difficult to complement appropriately. However, in the third embodiment, a plurality of pieces of writing pressure information are sent, and it is possible to perform interpolation with higher accuracy with the plurality of pieces of writing pressure information as a clue.

Meanwhile, in the third embodiment, a plurality of pieces of writing pressure information with a number of signals n which are not overlapped with each other are sent. However, the electronic pen 2 may send the pieces of writing pressure information which are overlapped with each other.

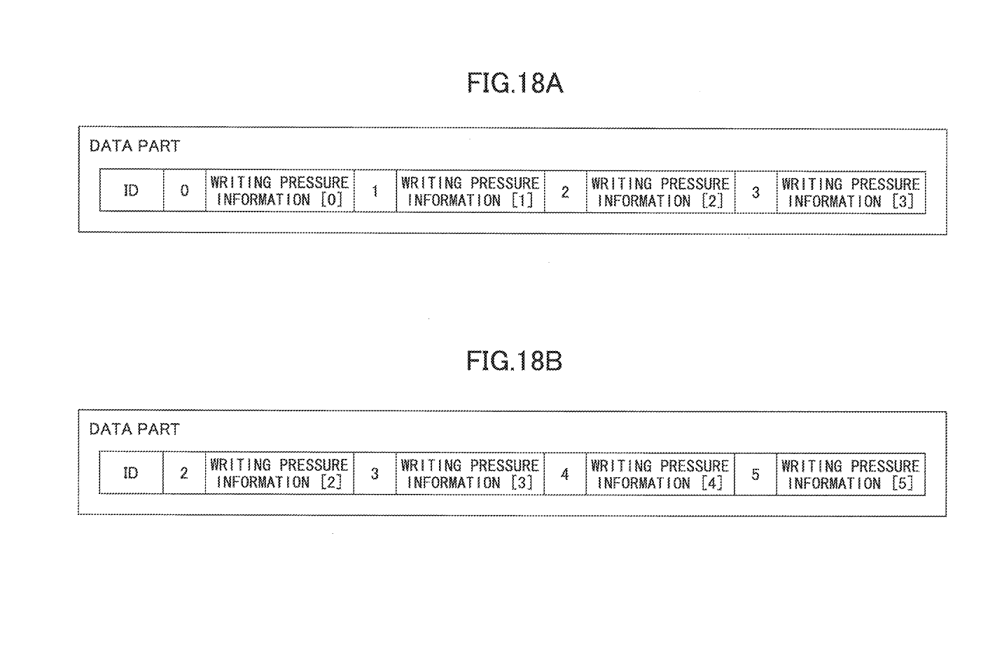

FIGS. 18A and 18B are diagrams schematically illustrating examples of a data part in a transmission datum according to the third embodiment. In FIG. 18A, pieces of writing pressure information [0] to [3] are sent. In FIG. 18B, pieces of writing pressure information [2] to [5] are sent. That is, the pieces of writing pressure information [2] and [3] are overlapped with each other and sent. Since two pieces of writing pressure information among four pieces of writing pressure information are overlapped, a substantial transmission frequency reduces to 50%. However, the electronic pen 2 can send the same number of pieces of writing pressure information per unit time with a smaller transmission frequency than the transmission frequency in the case of sending a piece of writing pressure information, as described below:

Transmission frequency in a case of sending a piece of writing pressure information . . . A Hz; and
Transmission frequency in a case of sending four pieces of writing pressure information which are not overlapped with each other . . . A/4 Hz.

Even in a case where two pieces of writing pressure information are overlapped among four pieces of writing pressure information, in order to send the same number of pieces of writing pressure information as the case of A/4 Hz, it only has to send with a frequency of A/2 Hz, which is one half of the transmission frequency in the case of sending a piece of writing pressure information with A Hz. Therefore, by overlapping the pieces of writing pressure information, a number of pieces of writing pressure information where data loss occurs is decreased, and thereby the transmission frequency can be reduced. Moreover, since the number of pieces of writing pressure information where data loss occurs is small, a load for the interpolation processing can be reduced and accuracy in a result of the interpolation is enhanced.

### Fourth Embodiment

In a fourth embodiment, a drawing system in which an electronic whiteboard (computer 100) 300 communicates with a plurality of electronic pens 2 will be described.

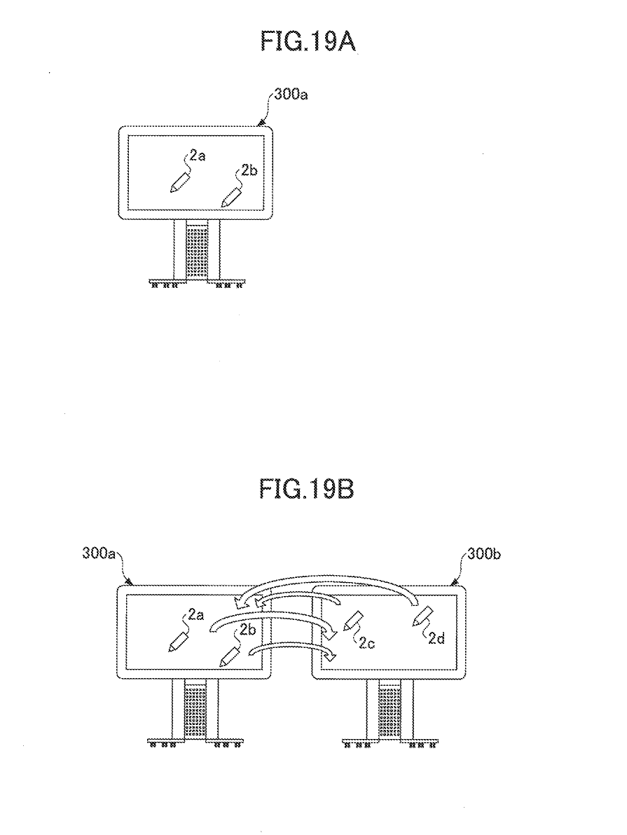

FIGS. 19A and 19B are diagrams for schematically explaining an example of the drawing system 400 according to the fourth embodiment. In FIG. 19A, two electronic pens 2a, 2b are used. The electronic whiteboard 300a receives pieces of writing pressure information from the electronic pens 2a, 2b, respectively. In this way, in a case where a plurality of electronic pens 2 are used on an electronic whiteboard 300, interference of electromagnetic waves is likely to occur due to the same frequency band or the like.

Moreover, electronic whiteboards 300a, 300b can be used arranged adjacent to each other, as shown in FIG. 19B. On the electronic whiteboard 300a, electronic pens 2a, 2b are used, and on the electronic whiteboard 300b, electronic pens 2c, 2d are used. Depending on a distance between the electronic whiteboards 300a and 300b, and on intensities of electromagnetic waves from the electronic pens 2a to 2d, the electronic whiteboard 300a receives electromagnetic waves from four electronic pens 2, i.e. the electronic pens 2a to 2d, and the electronic whiteboard 300b receives electromagnetic waves from four electronic pens 2, i.e. the electronic pens 2a to 2d.

This occurs because pairing is unnecessary for the electronic pens 2 and the electronic whiteboards 300, but even in a case where the pairing is necessary, it is the same from the point of view that electric waves may interfere with each other in the same frequency band. Therefore, the greater the number of the electronic pens 2 around the electronic whiteboards 300 is, the higher the possibility of interference is.

Then, in the fourth embodiment, a drawing system 400 in which a transmission frequency is decreased according to a number of electronic pens 2 communicating with an electronic whiteboard 300, and a number of signals is increased will be described.

<Regarding Function>

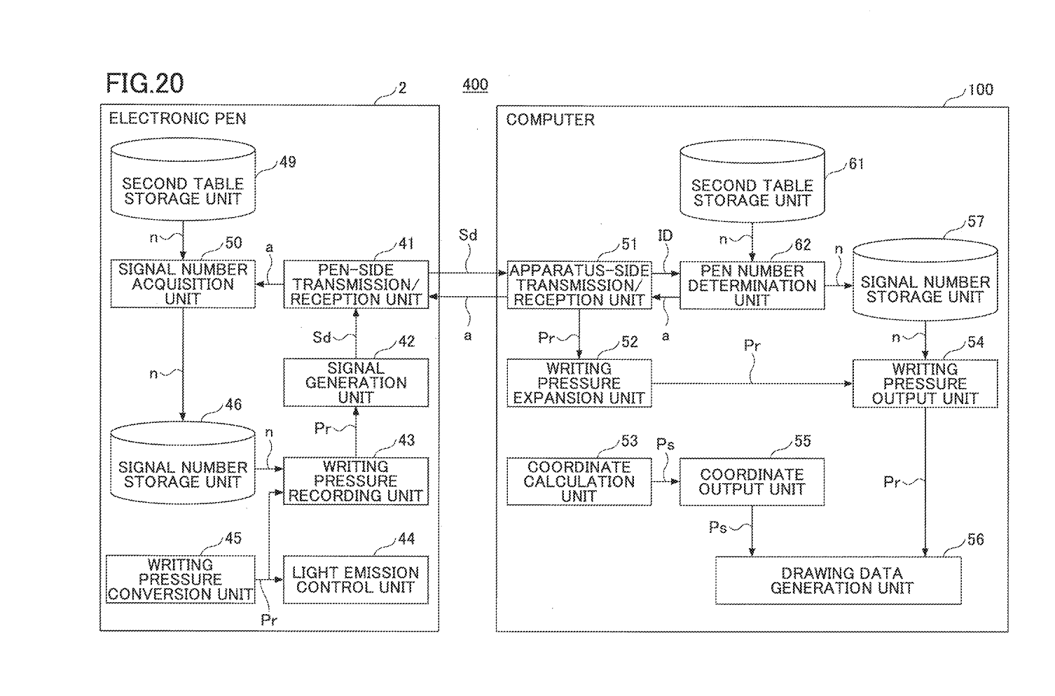

FIG. 20 is a functional block diagram illustrating an example of the drawing system 400 having the electronic pen 2 and the computer 100 according to the fourth embodiment. In the fourth embodiment, a member to which the same reference numeral as in FIG. 5 is assigned serves the same function, so that only a main member of the fourth embodiment may be mainly explained. According to the functional block diagram in FIG. 20, the electronic pen 2 includes a signal number acquisition unit 50 and a second table storage unit 49.

TABLE 2

| Number of | Transmission | Number of | N [number of |
|---|---|---|---|
| pens | frequency [Hz] | signals n | pieces/second] |
| 1 | 100 | 1 | 100 |
| 2 | 50 | 2 | 100 |
| 3 | 33 | 3 | 99 |
| 4 | 25 | 4 | 100 |
| 5 | 20 | 5 | 100 |
| 6 | 14 | 7 | 98 |
| 7 | 10 | 10 | 100 |

The second table storage unit 49 stores an electronic pen number table. In the electronic pen number table, the transmission frequency and the number of signals n are associated with each other corresponding to the number of the electronic pens 2. For convenience of explanation, numbers of pieces of writing pressure information sent per second N [number of pieces/second] are listed. However, the numbers of pieces of writing pressure information sent per second N may not be registered in the electronic pen number table. A developer in a manufacturer or the like can determine experimentally the transmission frequency for which interference is unlikely to occur with respect to the number of the electronic pens 2, thereby preparing a table as shown in TABLE 2.

The greater the number of the electronic pens 2 is, the smaller the transmission frequency is and correspondingly the greater the number of signals n is. However, the number of pieces of writing pressure information sent in a second N is almost constant. Therefore, even if the number of the electronic pens 2 is increased, the number of pieces of writing pressure information sent in the second N does not decrease. Meanwhile, the number of pieces of writing pressure information sent in the second N may increase or decrease with an increasing number of the electronic pens 2.

Returning to FIG. 20, explanation will be continued. The signal number acquisition unit 50 of the electronic pen 2 is a function or a means enabled by the CPU 26 of the electronic pen 2 executing a program for electronic pens. The signal number acquisition unit 50 of the electronic pen 2 reads out a transmission frequency and a number of signals n associated with the number of electronic pens 2, “a”, selected by the computer 100 from the electronic pen number table. The signal number acquisition unit 50 stores the number of signals n into the signal number storage unit 46.

Next, the computer 100 will be explained. The computer 100 includes a pen number determination unit 62 and a second table storage unit 61. The pen number determination unit 62 of the computer 100 is a function or a means enabled by the CPU 101 of the computer 100 executing the program for drawing system 119. The pen number determination unit 62 monitors transmission data received by the apparatus-side transmission/reception unit 51 and determines a number of IDs which are different from each other. Since the IDs are different for the respective electronic pens, the electronic pens 2, a number of which is the same as the number of IDs, exist around the computer 100. The pen number determination unit 62 sends the number of electronic pens 2, “a”, to the electronic pens 2.

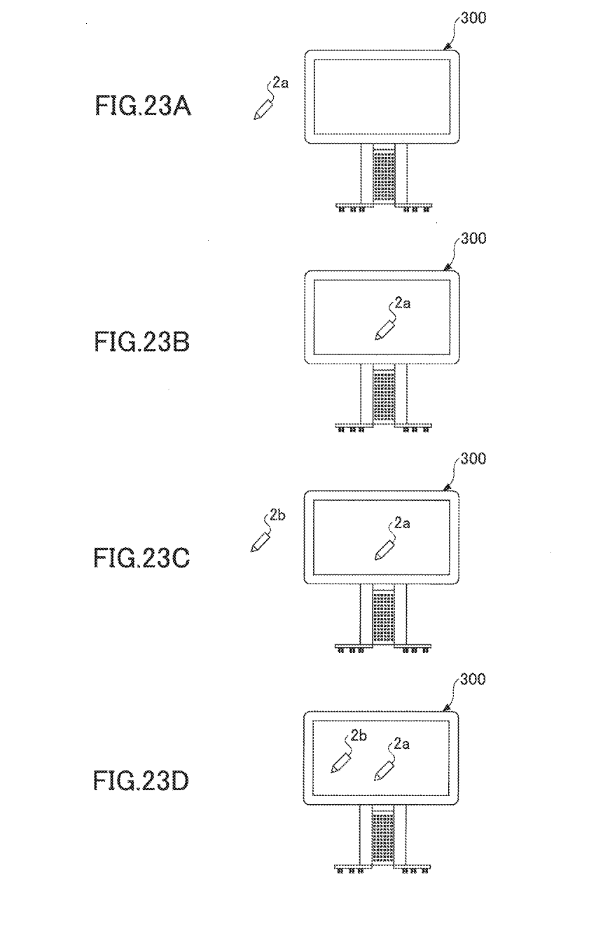

Meanwhile, an object of sending the number of electronic pens 2 from the computer 100 only has to be the electronic pen 2 inputting coordinates to the electronic whiteboard which is the own apparatus. For example, in FIG. 20, the electronic whiteboard 300a sends the number of electronic pens 2 only to the electronic pens 2a and 2b. A method of identifying the electronic pens 2a and 2b will be described later with reference to FIGS. 23A to 23D.

Moreover, the pen number determination unit 62 stores the number of signals n associated with the number of pens 2 from the second table storage unit 61 into the signal number storage unit 57.

Meanwhile, the pen number determination unit 62 may read out the transmission frequency and the number of signals n from the electronic pen number table in the second table storage unit 61 and send them to the electronic pen 2, instead of the number of electronic pens 2, “a”. In this case, the electronic pen 2 may not include the second table storage unit 49.

Moreover, the electronic pen 2 may detect the number of electronic pens 2 around it. In this case, the electronic pen 2 may send the transmission frequency and the number of signals n read out from the electronic pen number table to the computer 100, or may send the number of electronic pens 2.

Meanwhile, the computer 100 may download the electronic pen number table from a network. Moreover, the electronic pen 2 may download the electronic pen number table from the network, or may acquire the electronic pen number table from the computer 100.

<Operation Procedure>

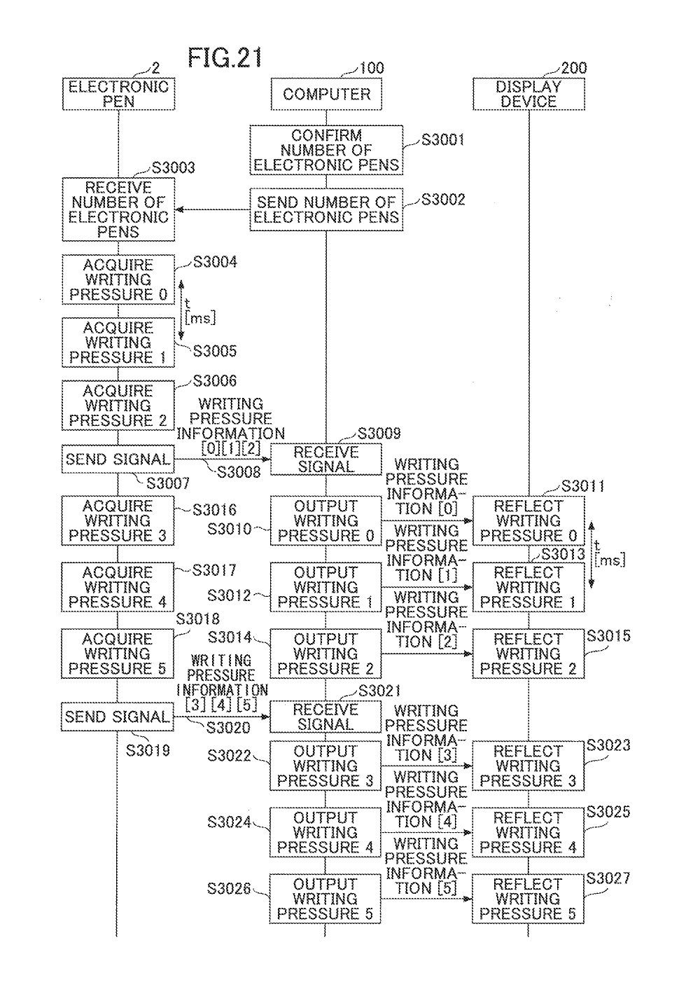

FIG. 21 is a sequence diagram illustrating an example of a procedure of sending transmission data to the computer 100 by the electronic pen 2 according to the fourth embodiment.

The pen number determination unit 62 of the computer 100 determines a number of the electronic pens 2 (step S3001). This process may be performed before starting communication or in the middle of the communication.

The pen number determination unit 62 sends a number of electronic pens 2 to the electronic pens 2 via the apparatus-side transmission/reception unit 51 (step S3002).

The pen-side transmission/reception unit 41 of the electronic pen 2 receives the number of electronic pens 2 (step S3003). The signal number acquisition unit 50 of the electronic pen 2 reads out a transmission frequency and a number of signals n from the electronic pen number table. According to the above-described processing, the signal number acquisition unit 50 of the electronic pen 2 changes the transmission frequency and stores the number of signals n into the signal number storage unit 46. In FIG. 21, the number of signals n is assumed to be “3”.

A process in step S3004 and later are the same as those in the first embodiment. That is, the electronic pen 2 sends three pieces of writing pressure information to the electronic whiteboard 300 in one transmission.

Meanwhile, the computer 100 can determine data loss as in the third embodiment, and can interpolate writing pressure information. Moreover, depending on whether the data loss occurs, the process of increasing or decreasing the transmission frequency or increasing or decreasing the number of signals n may be performed, as in the second embodiment. That is, the pen number determination unit 62 of the computer 100 determines initial values of the transmission frequency and the number of signals n. The pen number determination unit 62 can decrease the transmission frequency (increase the number of signals n) or increase the transmission frequency (decrease the number of signals n) depending on the degree of subsequent interference.

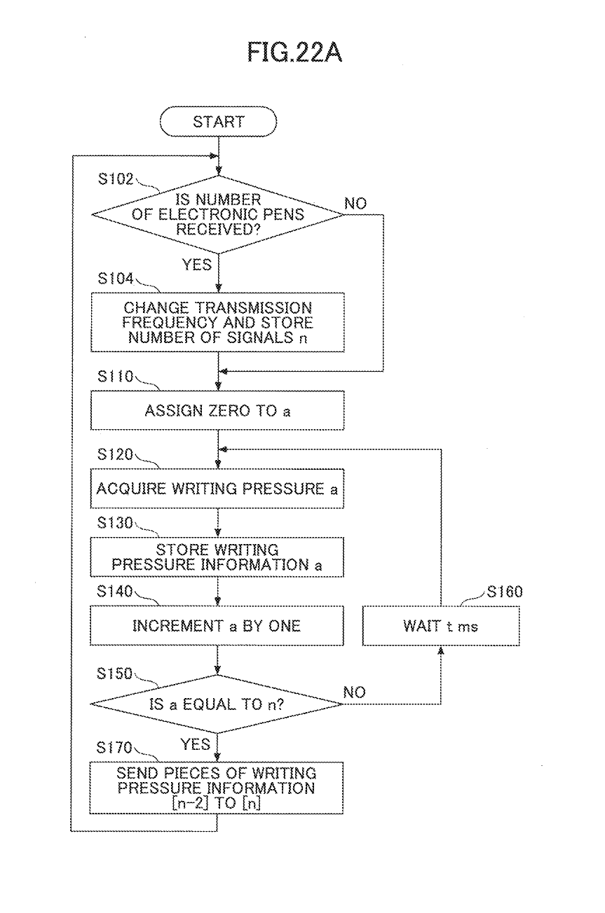

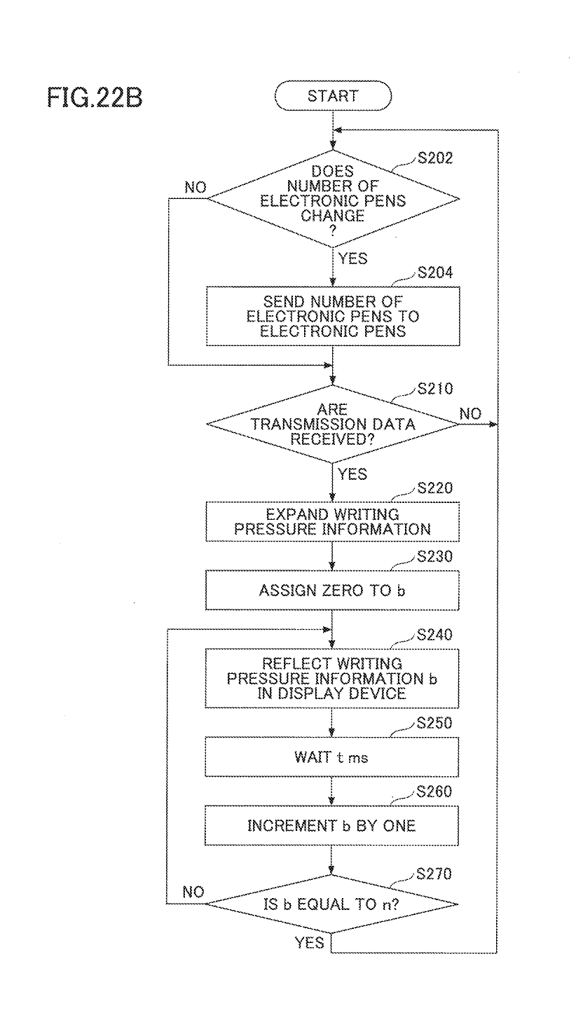

FIG. 22A is a flowchart illustrating an example of a procedure of the electronic pen 2 sending the transmission data according to the fourth embodiment. FIG. 22A is obtained by adding steps S102 and S104 to FIG. 8A. In the following, the processes in steps S102 and S104 will be explained.

The pen-side transmission/reception unit 41 determines whether to receive the number of electronic pens (step S102). In a case where the number of electronic pens is not received (step S102: NO), the processes in step S110 and later are performed as in the first embodiment.

In a case where the number of electronic pens is received (step S102: YES), the signal number acquisition unit 50 of the electronic pen 2 reads out the transmission frequency and the number of signals n from the electronic pen number table, changes the transmission frequency and stores the number of signals n into the signal number storage unit 46 (step S104). Subsequently, the processes in step S110 and later are performed as in the first embodiment depending on the number of signals n.

FIG. 22B is a flowchart illustrating an example of a procedure of the computer 100 receiving the transmission data according to the fourth embodiment. FIG. 22B is obtained by adding steps S202 and S204 to FIG. 8B. In the following, the processes in steps S202 and S204 will be explained.

The pen number determination unit 62 of the computer 100 determines whether the number of electronic pens 2 is changed (step S202). In a case where the number of electronic pens 2 is not changed (step S202: NO), the processes in step S210 and later are performed as in the first embodiment.

In a case where the number of electronic pens 2 is changed (step S202: YES), the pen number determination unit 62 of the computer 100 sends the number of electronic pens to the electronic pens 2 (step S204). Subsequently, the processes in step S210 and later are performed as in the first embodiment depending on whether the transmission data are received.

According to the fourth embodiment, in a case where a plurality of electronic pens 2 exist around the electronic whiteboard 300, the transmission frequency and the number of signals n can be controlled to be optimum values where interference does not occur.

<Identifying Electronic Pen 2 Used for Inputting Coordinates>

FIGS. 23A to 23D are diagrams for explaining a method of identifying by the computer 100 the electronic pen 2 used for inputting coordinates in the case where a plurality of electronic pens 2 exist. In FIG. 23A, an electronic pen 2a communicates with the electronic whiteboard 300 or at least can communicate with the electronic whiteboard 300, but the electronic pen 2a is not yet used for inputting coordinates.

In FIG. 23B, the electronic pen 2a is used for inputting coordinates. At this time, the coordinate calculation unit 53 of the computer 100 detects coordinates, and thereby the electronic pen 2a is detected to be used for inputting coordinates. The writing pressure expansion unit 52 identifies the electronic pen 2a used for inputting coordinates based on ID of transmission data of first contact information received at the same time, immediately before or immediately after the detection of coordinates. Therefore, the computer 100 can send the number of electronic pens to the electronic pen 2a.

In FIG. 23C, a second electronic pen 2b communicates with the electronic whiteboard 300 or at least can communicate with the electronic whiteboard 300, but the electronic pen 2b is not yet used for inputting coordinates. Therefore, the computer 100 does not send the number of electronic pens 2 to the electronic pen 2b (or may send the number of electronic pens 2).

In FIG. 23D, the electronic pen 2b is used for inputting coordinates. In the same way as above, the writing pressure expansion unit 52 identifies the electronic pen 2b used for inputting coordinates based on ID of transmission data of first contact information received at the same time, immediately before or immediately after the detection of coordinates. Therefore, the computer 100 can send the number of electronic pens to the second electronic pen 2b.

Meanwhile, ID is attached to a coordinate set calculated by the coordinate calculation unit 53 and ID is also attached to a piece of writing pressure information, and thereby the coordinate set and the piece of writing pressure information are linked to each other. The drawing data generation unit 56 can reflect the piece of writing pressure information of the electronic pen 2a to a line drawn by the electronic pen 2a and reflect the piece of writing pressure information of the electronic pen 2b onto a line drawn by the electronic pen 2b.

### Other Preferred Example

As described above, preferred embodiments for carrying out the present invention are described using examples. However, the present invention is not limited to these embodiments, but various variations and modifications may be made without departing from the scope of the present invention.

For example, the coordinates of the electronic pen 2 may be determined by the computer 100 based on ultrasonic waves emitted from the electronic pen 2 instead of obtaining by the computer 100 from triangulation for an image obtained by capturing infrared light. In a case of detecting ultrasonic waves at least two locations around the display device 200, coordinates of the electronic pen can be detected from a difference between the times at which the ultrasonic waves are detected.

Moreover, in the present embodiments, a piece of writing pressure information is reflected as a thickness of a line. But, the piece of writing pressure information may be reflected as another property of a drawing. For example, in a case of converting the piece of writing pressure information into a piece of gradation information, tone of the drawing object can be changed depending on the writing pressure. Moreover, in a case of converting the piece of writing pressure information into a piece of color information, color of the drawing object can be changed depending on the writing pressure.

Moreover, as a physical quantity to interact with the electronic pen 2, writing pressure information is sent. But, the physical quantity to interact with the electronic pen 2 is not limited to this. For example, a grip strength of a user (force to hold the electronic pen), an acceleration rate or a velocity occurring in the electronic pen, or the like may be sent. In a case of sending the grip strength, it is possible to use the grip strength in the same way as the piece of writing pressure information. In a case of sending the acceleration rate or the velocity, when the electronic pen 2 operates a mouse cursor or the like, the computer 100 can reflect the acceleration rate or the velocity as a transfer rate for moving the mouse cursor.

Moreover, a part or all of the functions of the above-described electronic pen or the computer 100 may be enabled by a dedicated hardware circuit (e.g. semiconductor integrated circuit or the like) in addition to that enabled as software.

In order to improve the usability viewed from the user, it is preferable to enhance the frequency to send the writing pressure information by the electronic pen. However, recently a number of electronic devices having installed wireless communication functions have increased, and an electromagnetic wave for sending the writing pressure information by the electronic pen may interfere with an electromagnetic wave by the other electronic device (environmental noise). Therefore, the higher the frequency at which the electronic pen sends the writing pressure information, the greater becomes the possibility of interfering with the environmental noise, and inconvenience that the writing pressure does not reach the electronic whiteboard may occur. Moreover, an inconvenience that with the higher frequency the electronic pen sends the writing pressure, the greater power consumption becomes, may occur.

In this way, conventionally, there is a problem that since it is difficult to increase the communication frequency between the electronic pen and the electronic whiteboard, it is difficult to increase an amount of information to be sent to the electronic whiteboard.

According to the present embodiment, a system, in which an amount of information sent from the electronic pen to the electronic whiteboard can be increased, can be provided.

What is claimed is:

1. A system comprising:
a first device configured to select an instruction position, including
a physical quantity detection unit configured to detect a physical quantity at fixed time intervals, the physical quantity acting on the first device; and
a physical quantity transmission unit configured to send a transmission datum including the physical quantity at the fixed time intervals detected by the physical quantity detection unit; and
a second device including
a position acquisition unit configured to acquire the instruction position selected by the first device, and generate information based on the instruction position;
a transmission data reception unit configured to receive the transmission datum;
a physical quantity extraction unit configured to extract the physical quantity at the fixed time intervals from the transmission datum received by the transmission data reception unit; and
an information display unit configured to reflect the physical quantity at the fixed time intervals extracted by the physical quantity extraction unit in the information generated by the position acquisition unit based on the acquired instruction position, and to send the information to a display device.

2. The system according to claim 1,
wherein the second device further includes a notification unit configured to send non-detection information to the first device, in a case of determining that the transmission datum sent from the physical quantity transmission unit is not received, and
wherein the first device includes a transmission frequency reduction unit configured to increase a number of physical quantities included in the transmission datum which the physical quantity transmission unit sends, and reduce a transmission frequency of sending the transmission datum, in a case of receiving the non-detection information.

3. The system according to claim 1,
wherein the second device includes a notification unit configured to send to the first device a transmission frequency of sending the transmission datum and a number of physical quantities included in the transmission datum, in a case of determining that the transmission datum sent from the physical quantity transmission unit is not received, and
wherein the physical quantity transmission unit of the first device is configured to send to the second device the transmission datum including the physical quantities, the number of which is received from the notification unit, with the transmission frequency received from the notification unit.

4. The system according to claim 1,
wherein the second device includes a number estimation unit configured to estimate a number of the first devices configured to communicate with the second device, and to send the estimated number of the first devices to at least one of the first devices,
wherein the first device includes a transmission frequency determination unit configured to determine, a transmission frequency of sending the transmission datum and a number of physical quantities included in the transmission datum, according to the number of the first devices received from the second device, and
wherein the physical quantity transmission unit is configured to send to the second device, the transmission datum including the physical quantities, the number of which is determined by the transmission frequency determination unit, with the transmission frequency determined by the transmission frequency determination unit.

5. The system according to claim 1,
wherein the second device includes a number estimation unit configured to estimate a number of the first devices configured to communicate with the second device, and to send to at least one of the first devices a number of physical quantities included in the transmission datum and a transmission frequency of sending the transmission datum, the number of the physical quantities and the transmission frequency being determined according to the number of the first devices, and
wherein the physical quantity transmission unit of the first device is configured to send to the first device the transmission datum including the physical quantities, the number of which is received from the second device, with the transmission frequency received from the second device.

6. The system according to claim 2,
wherein the second device is configured to cause the first device to reduce the transmission frequency of sending the transmission datum and to increase the number of physical quantities included in the transmission datum, in a case of determining that the transmission datum sent from the physical quantity transmission unit is not received, and
wherein the second device is configured to cause the first device to increase the transmission frequency of sending the transmission datum and to reduce the number of the physical quantities included in the transmission datum, in a case where the transmission datum is received stably.

7. The system according to claim 2,
wherein a number of the physical quantities, which the physical quantity transmission unit of the first device sends in a unit time, remains almost constant even in a case where the number of physical quantities included in the transmission datum and the transmission frequency of sending the transmission datum are changed.

8. The system according to claim 1,
wherein the second device includes a physical quantity estimation unit configured to estimate, in a case of determining that the transmission datum sent from the physical quantity transmission unit is not received, a physical quantity included in the transmission datum, which is not received, by using at least a physical quantity included in a transmission datum, which was received in a past, and
wherein the information display unit is configured to reflect the physical quantity estimated by the physical quantity estimation unit in the information generated by the position acquisition unit based on the acquired instruction position.

9. The system according to claim 8,
wherein the information display unit is configured to reflect the physical quantity estimated by the physical quantity estimation unit in information generated by the position acquisition unit based on the acquired instruction position, the physical quantity included in the transmission datum, which is not received, not being reflected in the information.

10. The system according to claim 1,
wherein the physical quantity transmission unit of the first device is configured to send a transmission datum including a physical quantity included in the transmission datum, which was sent previously.

11. The system according to claim 1,
wherein the physical quantity is a writing pressure, a grip strength, an acceleration rate, or a velocity.

12. A drawing method in a system including a first device configured to select an instruction position and a second device configured to acquire the instruction position, the drawing method comprising:
detecting a physical quantity at fixed time intervals, the physical quantity acting on the first device;
sending from the first device a transmission datum including the detected physical quantity at the fixed time intervals;
acquiring at the second device the instruction position selected by the first device, and generating information based on the instruction position;
receiving at the second device the transmission datum;
extracting at the second device the physical quantity at the fixed time intervals from the received transmission datum; and
reflecting the extracted physical quantity at the fixed time intervals in the information generated based on the acquired instruction position, and sending the information to a display device.

13. An information processing apparatus for receiving a transmission data from a first device configured to select an instruction position, the first device including a physical quantity detection unit configured to detect a physical quantity acting on the first device at fixed time intervals; and a physical quantity transmission unit configured to send the transmission datum including the physical quantity at the fixed time intervals detected by the physical quantity detection unit, the information processing apparatus comprising:
a position acquisition unit configured to acquire the instruction position selected by the first device, and generate information based on the instruction position;
a transmission data reception unit configured to receive the transmission datum;
a physical quantity extraction unit configure to extract the physical quantity at the fixed time intervals from the transmission datum received by the transmission data reception unit; and
an information display unit configured to reflect the physical quantity at the fixed time intervals extracted by the physical quantity extraction unit in the information generated by the position acquisition unit based on the acquired instruction position, and to send the information to a display device.
